(19) United States
(12) Patent Application Publication
(10) Pub. No.: US 2023/0304604 A1
(43) Pub. Date: Sep. 28, 2023

(54) INFLATABLE PIPE DRUM SYSTEMS AND METHODS

(71) Applicant: Trinity Bay Equipment Holdings, LLC, Houston, TX (US)

(72) Inventors: Andrew David Ethridge, Oak Ridge, TN (US); Alexander Lee Winn, Spring, TX (US)

(21) Appl. No.: 17/704,132

(22) Filed: Mar. 25, 2022

(51) Int. Cl. F16L 1/06; B66D 1/30

(52) U.S. Cl. CPC F16L 1/06; B66D 1/30; F16L 1/065

(57) ABSTRACT

Techniques for implementing and/or operating a system that includes an inflatable pipe drum, an inflation fluid source, and flexible pipe, which is formed into a pipe coil. The inflatable pipe drum includes an inflatable drum bladder that defines an internal fluid cavity, in which the inflatable pipe drum is to be inserted into a coil bore of the pipe coil while the inflatable drum bladder is in a less inflated state, and a fluid valve secured to the inflatable drum bladder such that the fluid valve is fluidly connected to the internal fluid cavity defined in the inflatable drum bladder. The inflation fluid source supplies inflation fluid to the internal fluid cavity defined in the inflatable drum bladder via the fluid valve to facilitate transitioning the inflatable drum bladder from the less inflated state to a more inflated state to facilitate supporting the pipe coil from within the coil bore.

### BACKGROUND

The present disclosure generally relates to pipeline systems and, more particularly, to an inflatable pipe drum that may be used to support a coil of flexible pipe that is to be deployed in a pipeline system.

Pipeline systems are often used to convey (e.g., transport) fluid, such as liquid and/or gas, from a fluid source to a fluid destination. For example, a pipeline system may be used to transport one or more hydrocarbons, such as crude oil, petroleum, natural gas, or any combination thereof. Additionally or alternatively, a pipeline system may be used to transport one or more other types of fluid, such as produced water, potable water, fresh water, fracturing fluid, flowback fluid, carbon dioxide, or any combination thereof.

To facilitate transporting fluid, a pipeline system generally includes pipe (e.g., one or more pipe segments) in addition to pipe (e.g., midline and/or end) fittings, which are used to connect a pipe segment to another pipeline component, such as another pipe fitting, another pipe segment, a fluid source, and/or a fluid destination. Generally, a pipe includes tubing, which defines (e.g., encloses) a pipe bore that provides a primary fluid conveyance (e.g., flow) path through the pipe. More specifically, the tubing of a pipe may be implemented to facilitate isolating (e.g., insulating) fluid being conveyed within its pipe bore from environmental conditions external to the pipe, for example, to reduce the likelihood of the conveyed (e.g., bore) fluid being lost to the external environmental conditions and/or the external environmental conditions contaminating the conveyed fluid (e.g., clean and/or potable water).

Additionally, in some instances, pipe deployed or to be deployed in a pipeline system may be flexible. In fact, in some instances, flexible pipe may be formed (e.g., wound, wrapped, and/or spooled) into a pipe coil having a first circular base, a second (e.g., opposite) circular base, a cylindrical outer surface, and a coil bore that extends axially therethrough and, thus, an open cylindrical (e.g., tubular) shape, for example, for transportation and/or storage before at least a segment of the flexible pipe is deployed from the pipe coil into a pipeline system. In fact, in some such instances, flexible pipe may be deployed from a pipe coil directly into a pipeline system. However, at least in some instances, deploying flexible pipe from a pipe coil into a pipeline system may be challenging, for example, due to force, such as gravity, translational force, and/or rotational force, exerted on the pipe coil inadvertently causing the pipe coil to deform from its target (e.g., open cylindrical) shape.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, a system includes flexible pipe, an inflatable pipe drum, and an inflation fluid source. The flexible pipe is formed into a pipe coil that includes a coil bore that extends axially therethrough, in which tubing of the flexible pipe defines a pipe bore and a fluid conduit within a tubing annulus of the flexible pipe. The inflatable pipe drum includes an inflatable drum bladder that defines an internal fluid cavity, in which the inflatable pipe drum is to be inserted into the coil bore of the pipe coil while the inflatable drum bladder is in a less inflated state, and a fluid valve secured to the inflatable drum bladder such that the fluid valve is fluidly connected to the internal fluid cavity defined in the inflatable drum bladder. The inflation fluid source supplies inflation fluid to the internal fluid cavity defined in the inflatable drum bladder via the fluid valve to facilitate transitioning the inflatable drum bladder from the less inflated state to a more inflated state in which the inflatable drum bladder is radially compressed against the pipe coil to facilitate supporting the pipe coil from within the coil bore using the inflatable pipe drum.

In another embodiment, a method of using an inflatable pipe drum includes inserting the inflatable pipe drum into a coil bore of a pipe coil that is formed from flexible pipe while an inflatable drum bladder of the inflatable pipe drum is in a less inflated state, supplying inflation fluid from an inflation fluid source to an internal fluid cavity defined within the inflatable drum bladder via a fluid valve secured to the inflatable drum bladder to transition the inflatable drum bladder from the less inflated state to a more inflated state in which the inflatable drum bladder is circumferentially compressed against the pipe coil to facilitate supporting the pipe coil from within the coil bore using the inflatable pipe drum, and disconnecting the inflation fluid source from the fluid valve of the inflatable pipe drum after the inflatable drum bladder is transitioned to the more inflated state.

In another embodiment, an inflatable pipe drum includes an inflatable drum bladder and a fluid valve. The inflatable drum bladder includes bladder walls that define an internal fluid cavity within the inflatable drum bladder such that the inflatable drum bladder has a cylindrical shape and the inflatable pipe drum is to be inserted into a coil bore of a pipe coil while the inflatable drum bladder is in a less inflated state. The fluid valve is secured to a bladder wall of the inflatable drum bladder such that the fluid valve opens through the bladder wall to the internal fluid cavity defined in the inflatable drum bladder, in which the fluid valve maintains an open state to enable inflation fluid to be supplied from an inflation fluid source to the internal fluid cavity defined in the inflatable drum bladder to facilitate transitioning the inflatable drum bladder from the less inflated state to a more inflated state in which the inflatable drum bladder is circumferentially compressed against the pipe coil and, thus, supports the pipe coil from within the coil bore of the pipe coil and transitions from the open state to a closed state to lock inflation fluid in the internal fluid cavity defined in the inflatable drum bladder at an elevated fluid pressure to facilitate maintaining the inflatable drum bladder in the more inflated state.

### BRIEF DESCRIPTION OF DRAWINGS

FIG. 1 is a block diagram of an example of a pipeline system including pipe segments and pipe fittings, in accordance with an embodiment of the present disclosure.

FIG. 2 is a side view of an example of a pipe that includes a pipe bore defined by its tubing as well as fluid conduits defined within an annulus of its tubing, in accordance with an embodiment of the present disclosure.

FIG. 3 is a perspective view of an example of a portion of a pipe that includes a helically shaped fluid conduit defined within the annulus of its tubing, in accordance with an embodiment of the present disclosure.

FIG. 4 is a perspective view of an example of a pipe coil disposed on an example of a pipe skid, in accordance with an embodiment of the present disclosure.

FIG. 5 is a side view of an example of an inflatable pipe drum disposed within a coil bore of a pipe coil while its inflatable drum bladder is in a less inflated state, in accordance with an embodiment of the present disclosure.

FIG. 6 is a radial cross-sectional view of an example of the inflatable pipe drum of FIG. 5, in accordance with an embodiment of the present disclosure.

FIG. 7 is a side view of the example of the inflatable pipe drum of FIG. 5 disposed within the coil bore of the pipe coil while its inflatable drum bladder is in a more inflated state, in accordance with an embodiment of the present disclosure.

FIG. 8 is a side view of another example of an inflatable pipe drum disposed within a coil bore of a pipe coil while each of its inflatable drum bladders is in its more inflated state, in accordance with an embodiment of the present disclosure.

FIG. 9 is side view of an example of a pipe lifting device and the other example of the inflatable pipe drum of FIG. 7 disposed within the coil bore of the pipe coil while an upper inflatable bladder of the inflatable pipe drum is in its less inflated state, in accordance with an embodiment of the present disclosure.

FIG. 10 is a side view of an example of a pipe lifting device and a further example of an inflatable pipe drum disposed within a coil bore of a pipe coil while its inflatable drum bladder is in its more inflated state, in accordance with an embodiment of the present disclosure.

FIG. 11 is a radial cross-sectional view of an example of the inflatable pipe drum of FIG. 10, in accordance with an embodiment of the present disclosure.

FIG. 12 is a side view of another example of an inflatable pipe drum disposed within a coil bore of a pipe coil while each its inflatable drum bladders is in its more inflated state, in accordance with an embodiment of the present disclosure.

FIG. 13 is an axial cross-sectional view of a further example of an inflatable pipe drum disposed within a coil bore of a pipe coil while each its inflatable drum bladders is in its more inflated state, in accordance with an embodiment of the present disclosure.

FIG. 14 is a block diagram of an example of a pipe handling system that includes an inflatable pipe drum and a pipe coil loaded therein, in accordance with an embodiment of the present disclosure.

FIG. 15 is a flow diagram of an example of a process for implementing (e.g., manufacturing) an inflatable pipe drum, in accordance with an embodiment of the present disclosure.

FIG. 16 is flow diagram of an example of a process for operating (e.g., using) an inflatable pipe drum, in accordance with an embodiment of the present disclosure.

### DETAILED DESCRIPTION

One or more specific embodiments of the present disclosure will be described below with reference to the figures. As used herein, the term “coupled” or “coupled to” may indicate establishing either a direct or indirect connection and, thus, is not limited to either unless expressly referenced as such. The term “set” may refer to one or more items. Wherever possible, like or identical reference numerals are used in the figures to identify common or the same features. The figures are not necessarily to scale. In particular, certain features and/or certain views of the figures may be shown exaggerated in scale for purposes of clarification.

The present disclosure relates to pipeline systems, which generally include pipe (e.g., one or more pipe segments) secured and sealed in pipe fittings, such as a midline pipe fitting and/or a pipe end fitting. In particular, in some instances, pipe deployed in a pipeline system may include flexible pipe. In fact, in some instances, flexible pipe may be formed (e.g., wound wrapped, and/or spooled) into a pipe coil having a coil bore that extends axially therethrough, a first circular base, a (e.g., opposite) second circular base, and a cylindrical outer surface, for example, for transportation and/or storage before at least a segment of the flexible pipe is deployed from the pipe coil into a pipeline system. In other words, a target shape of a pipe coil may be an open cylindrical (e.g., tubular) shape that has circular ring-shaped ends (e.g., bases).

Additionally, to facilitate deploying flexible pipe from a pipe coil directly into a pipeline system, in some instances, the pipe coil may be loaded on pipe deployment equipment in a pipe handling system such that the pipe coil can rotate on the pipe deployment equipment. Accordingly, at least in such instances, maintaining a target (e.g., open cylindrical) shape of a pipe coil may facilitate rotating the pipe coil on pipe deployment equipment and, thus, deploying flexible pipe from the pipe coil into a pipeline system.

However, at least in some instances, when its coil bore is unsupported, force exerted on a pipe coil may cause the pipe coil to inadvertently deform (e.g., deviate and/or differ) from its target (e.g., open cylindrical) shape. For example, translational force resulting from translational movement (e.g., transportation) of a pipe coil may cause the pipe coil to lean to one side and/or to ovalize. Additionally or alternatively, downward force resulting from gravity may cause the pipe coil to ovalize and/or to lean to one side, for example, due to pipe wraps in the pipe coil being skewed (e.g., not parallel and not perpendicular) relative to a central axis of the pipe coil.

To facilitate maintaining the target shape of a pipe coil, a pipe drum may be disposed within the coil bore of the pipe coil such that the pipe coil circumferentially engages the pipe drum, thereby supporting the pipe coil from within its coil bore. However, at least in some instances, the coil bores in different pipe coils may have different diameters, for example, when the pipe coils are formed from different diameter flexible pipes. In other words, at least in such instances, utilizing a fixed diameter pipe drum to support a pipe coil may potentially limit deployment efficiency of a pipeline system, for example, due the pipe coil having to be formed (e.g., wound and/or spooled) directly on the fixed diameter pipe drum and/or different fixed diameter pipe drums having to be used with pipe coils formed from different diameter flexible pipe.

Accordingly, to facilitate improving pipeline deployment efficiency, the present disclosure provides techniques for implementing and/or operating an inflatable pipe drum, which has an adaptively (e.g., selectively and/or dynamically) adjustable diameter, for example, to enable the inflatable pipe drum to be inserted into the coil bore of a pipe coil after the pipe coil is initially formed and/or to enable the inflatable drum to be used to support pipe coils that are formed from different diameter flexible pipe. To enable its diameter to be adaptively adjusted, an inflatable pipe drum generally includes one or more inflatable drum bladders, which each includes bladder walls that define one or more internal fluid cavities.

In particular, an inflatable drum bladder in an inflatable pipe drum may generally expand radially outward when inflation fluid, such as compressed air, nitrogen gas, and/or water, is supplied to an internal fluid cavity defined therein. Accordingly, when an inflatable pipe drum is disposed within a coil bore of a pipe coil, supplying inflation fluid to an inflatable drum bladder in the inflatable pipe drum to transition the inflatable drum bladder from a less inflated (e.g., deflated) state toward a more (e.g., partially or fully) inflated state may result in the inflatable drum bladder being compressed against the pipe coil, thereby supporting the pipe coil from within its coil bore and, thus, reducing the likelihood of force exerted on the pipe coil inadvertently causing the pipe coil to deform from its target shape. On the other hand, an inflatable drum bladder in an inflatable pipe drum may generally contract radially inward when inflation fluid is extracted (e.g., released) from an internal fluid cavity defined therein. Accordingly, extracting inflation fluid from an inflatable drum bladder in an inflatable pipe drum to transition the inflatable drum bladder from a more inflated state toward a less inflated state may result in the inflatable drum bladder being disengaged from a corresponding pipe coil, for example, to enable the inflatable pipe drum to be inserted into the coil bore of the pipe coil, the inflatable pipe drum to be withdrawn from the coil bore of the pipe coil, and/or a pipe lifting device, which is to be used to lift the pipe coil, to be inserted into the coil bore of the pipe coil.

To facilitate controlling the amount of inflation fluid within an internal fluid cavity in an inflatable drum bladder and, thus, a corresponding inflation state, an inflatable pipe drum additionally generally includes one or more fluid valves, which are each secured to the inflatable drum bladder such that it is fluidly connected to an internal fluid cavity defined in the inflatable drum bladder. Furthermore, to supply inflation fluid to and/or extract inflation fluid from an internal fluid cavity defined in an inflatable drum bladder and, thus, control a corresponding inflation state, an inflation fluid source, such as a compressed air tank and/or a fluid pump, may be connected to a corresponding fluid valve via one or more external fluid conduits, such as a hose. Additionally or alternatively, a fluid valve in an inflatable pipe drum may release inflation fluid from a corresponding inflatable drum bladder directly into external environmental conditions.

In any case, to facilitate circumferentially supporting a pipe coil from within its coil bore, in some embodiments, an inflatable pipe drum may include a single inflatable drum bladder that has a closed cylindrical shape. However, in other embodiments, an inflatable pipe drum may include multiple inflatable drum bladders and/or a different shaped inflatable drum bladder. For example, to facilitate inserting a pipe lifting device, which is to be used to lift a pipe coil, into the coil bore of the pipe coil, in some embodiments, an inflatable pipe drum may include a central inflatable drum bladder, which has a rectangular prism shape, a first side (e.g., upper and/or top) inflatable drum bladder, which has a cylindrical segment shape and is disposed on a first side of (e.g., above) the central inflatable drum bladder, and a second side (e.g., lower and/or bottom) inflatable drum bladder, which has a cylindrical segment shape and is disposed on a second (e.g., opposite) side of (e.g., below) the central inflatable drum bladder. Accordingly, to enable a pipe lifting device to be inserted into the coil bore of the pipe coil, in such embodiments, the first side inflatable drum bladder may be transitioned to its less inflated state, for example, whereas the central inflatable drum bladder and the second side inflatable drum bladder are maintained in their more inflated state to continue supporting a remainder (e.g., majority) of the pipe coil while the pipe coil is being moved (e.g., lifted).

Additionally, in other embodiments, an inflatable drum bladder in an inflatable pipe drum may have an open cylindrical (e.g., tubular) shape. In other words, in such embodiments, an open cylindrical inflatable drum bladder may define a bladder bore that extends axially therethrough. In particular, in some such embodiments, a bladder bore in an open cylindrical inflatable drum bladder may remain open to enable a pipe lifting device to be inserted into the bladder bore and, thus, a coil bore of a corresponding pipe coil while the open cylindrical inflatable drum bladder remains in its more inflated state and, thus, continues supporting the pipe coil. In other words, including an open cylindrical inflatable drum bladder with an open bladder bore in an inflatable pipe drum may enable the inflatable pipe drum to continue circumferentially supporting a pipe coil while the pipe coil is being moved (e.g., lifted) via a pipe lifting device.

Nevertheless, in other embodiments, an open cylindrical inflatable drum bladder in an inflatable pipe drum may be disposed circumferentially around a fixed drum core, which has fixed dimension, and, thus, the fixed drum core may be disposed within the bladder bore of the open cylindrical inflatable drum bladder. In particular, in some such embodiments, a fixed drum core of an inflatable pipe drum may include support wings, which extend out radially at either axial end of an inflatable drum bladder to facilitate blocking the inflatable drum bladder from inadvertently deforming axially and, thus, improving radial support the inflatable drum bladder provides to a corresponding pipe coil while the inflatable drum bladder is in its more inflated state. Additionally, in some such embodiments, a fixed drum core of an inflatable pipe drum may include drum shafts, which extend out axially and are implemented to interlock with shaft hubs on pipe deployment equipment to facilitate rotating the inflatable pipe drum and, thus, a corresponding pipe coil on the pipe deployment equipment. Furthermore, in some such embodiments, a fixed drum core of an inflatable pipe drum may include forklift channels (e.g., pockets), which are each implemented to accommodate a tine of a forklift to enable the forklift to move (e.g., lift and/or transport) the inflatable pipe drum and, thus, a corresponding pipe coil, for example, onto and/or off of pipe deployment equipment without using a separate pipe lifting device. In any case, in this manner, as will be described in more detail below, the present disclosure provides techniques for implementing and/or operating an inflatable pipe drum, which, at least in some instances, may facilitate improving pipeline deployment efficiency, for example, by enabling the inflatable pipe drum to be inserted into a coil bore of a pipe coil after the pipe coil is initially formed and/or by enabling the inflatable drum to be used to support pipe coils that are formed from different diameter flexible pipe.

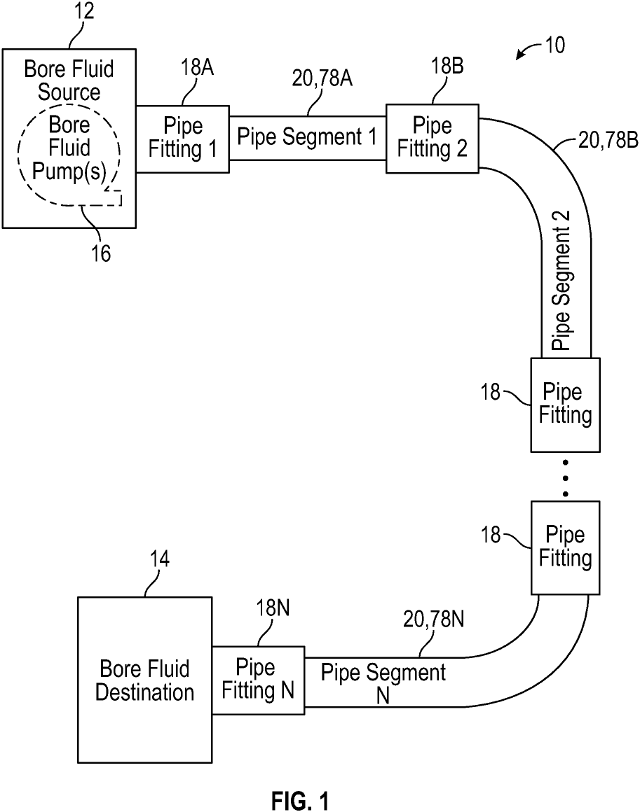

To help illustrate, an example of a pipeline system 10 is shown in FIG. 1. As in the depicted example, a pipeline system 10 may generally be coupled between a bore fluid source 12 and a bore fluid destination 14. Merely as an illustrative non-limiting example, the bore fluid source 12 may be a production well and the bore fluid destination 14 may be a fluid storage tank. In other instances, the bore fluid source 12 may be a first (e.g., lease facility) storage tank and the bore fluid destination 14 may be a second (e.g., refinery) storage tank.

In any case, a pipeline system 10 generally facilitates transporting (e.g., conveying) fluid, such as gas and/or liquid, from a bore fluid source 12 to a bore fluid destination 14. In fact, in some embodiments, a pipeline system 10 may be used in many applications, including without limitation, both onshore and offshore oil and gas applications. For example, in such embodiments, the pipeline system 10 may be used to transport one or more hydrocarbons, such as crude oil, petroleum, natural gas, or any combination thereof. Additionally or alternatively, the pipeline system 10 may be used to transport one or more other types of fluid, such as produced water, fresh water, fracturing fluid, flowback fluid, carbon dioxide, or any combination thereof.

To facilitate flowing fluid to a bore fluid destination 14, in some embodiments, a bore fluid source 12 in a pipeline system 10 may include one or more bore fluid pumps 16, which operate to inject (e.g., pump and/or supply) fluid from the bore fluid source 12 into a bore of the pipeline system 10. However, it should be appreciated that the depicted example is merely intended to be illustrative and not limiting. In particular, in other embodiments, a bore fluid pump 16 may not be included at a bore fluid source 12, for example, when fluid flow through the bore of a corresponding pipeline system 10 is produced by gravity. Additionally or alternatively, in other embodiments, a bore fluid pumps 16 may be included in a pipeline system 10 and/or at a bore fluid destination 14.

In any case, to facilitate transporting fluid from a bore fluid source 12 to a bore fluid destination 14, a pipeline system 10 generally include pipe fittings 18 and pipe 20, which is implemented using one or more pipe segments 78. For example, the depicted pipeline system 10 includes a first pipe segment 78A, a second pipe segment 78B, and an Nth pipe segment 78N. Additionally, the depicted pipeline system 10 includes a first pipe (e.g., end) fitting 18A, which connects the bore fluid source 12 to the first pipe segment 78A, a second pipe (e.g., midline) fitting 18B, which connects the first pipe segment 78A to the second pipe segment 78B, and an Nth pipe (e.g., end) fitting 18N, which connects the Nth pipe segment 78N to the bore fluid destination 14.

However, it should again be appreciated that the depicted example is merely intended to be illustrative and not limiting. In particular, in other embodiments, a pipeline system 10 may include fewer than five (e.g., four, three, or fewer) pipe fittings 18 or more than five (e.g., six, seven, or more) pipe fittings 18. Additionally or alternatively, in other embodiments, a pipeline system 10 may include fewer than three (e.g., two or one) pipe segments 78 or more than three (e.g., four, five, or more) pipe segment 78.

In any case, as described above, a pipe 20 generally includes tubing that may be used to convey (e.g., transfer and/or transport) water, gas, oil, and/or any other suitable type of fluid. The tubing of a pipe 20 may be made of any suitable type of material, such as plastic, metal, and/or a composite (e.g., fiber-reinforced composite) material. In fact, as will be described in more detail below, in some embodiments, the tubing of a pipe 20 may include multiple different tubing layers. For example, the tubing of a pipe 20 may include a first high-density polyethylene (e.g., internal corrosion protection) layer, one or more intermediate (e.g., metal, composite, and/or reinforcement) layers external to the first high-density polyethylene layer, and a second high-density polyethylene (e.g., external corrosion protection) layer external to the one or more intermediate layers.

Additionally, as in the depicted example, one or more (e.g., second and/or Nth) pipe segments 78 in a pipeline system 10 may be curved. To facilitate implementing a curve in a pipe 20, in some embodiments, the pipe 20 may be flexible, for example, such that the pipe 20 can be formed (e.g., wound, wrapped, and/or spooled) into a coil (e.g., during transport and/or before deployment of the pipe 20). In other words, in some embodiments, pipe 20 deployed or to be deployed in a pipeline system 10 may be flexible pipe 20, such as bonded flexible pipe, unbonded flexible pipe, flexible composite pipe (FCP), thermoplastic composite pipe (TCP), or reinforced thermoplastic pipe (RTP). In fact, at least in some instances, increasing flexibility of a flexible pipe 20 may facilitate improving deployment efficiency of a pipeline system 10, for example, by obviating a curved (e.g., elbow) pipe fitting 18 and/or enabling the flexible pipe 20 to be transported to the pipeline system 10, deployed in the pipeline system 10, or both using a pipe coil.

To facilitate improving pipe flexibility, in some embodiments, the tubing of a flexible pipe 20 that defines (e.g., encloses) its pipe bore may additionally define free space (e.g., one or more gaps) devoid of solid material within its annulus. In fact, in some embodiments, free space defined within the tubing of a flexible pipe 20 may run (e.g., span) the length of the flexible pipe 20 and, thus, define (e.g., enclose) a fluid conduit (e.g., free space) in the annulus of the tubing, which is separate from the pipe bore. In other words, in such embodiments, fluid may flow through a flexible pipe 20 via its pipe bore, free space (e.g., gaps and/or one or more fluid conduits) defined within its tubing annulus, or both.

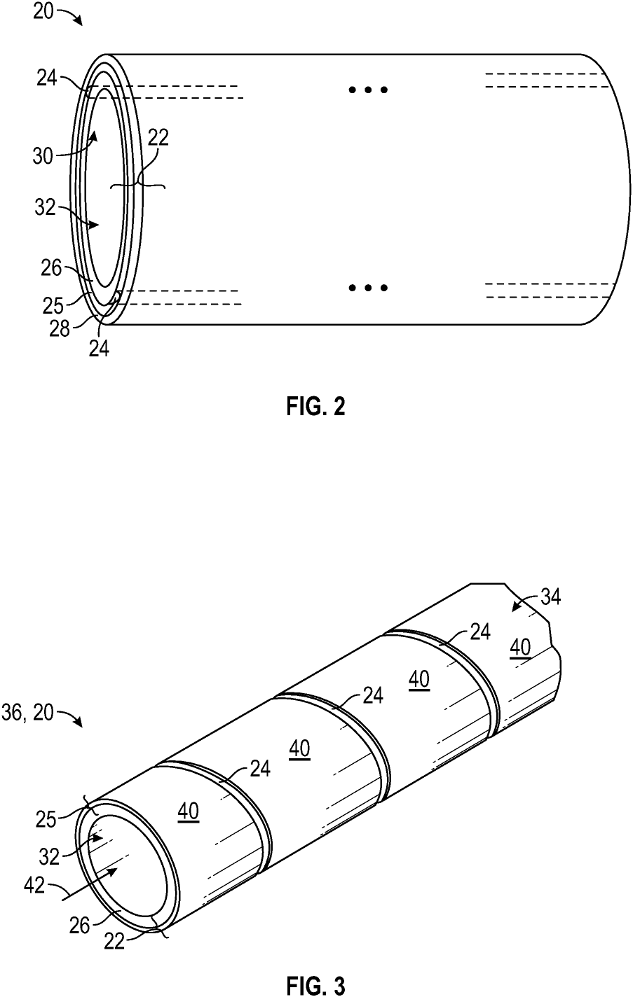

To help illustrate, an example of a flexible pipe 20, which includes tubing 22 with fluid conduits (e.g., free space) 24 defined in its annulus 25, is shown in FIG. 2. As depicted, the flexible pipe tubing 22 has multiple tubing layers including an inner barrier (e.g., liner) layer 26 and an outer barrier (e.g., shield and/or sheath) layer 28. In some embodiments, the inner barrier layer 26 and/or the outer barrier layer 28 of the flexible pipe tubing 22 may formed from composite material and/or plastic, such as high-density polyethylene (HDPE), raised temperature polyethylene (PE-RT), cross-linked polyethylene (XLPE), polyamide 11 (PA-11), polyamide 12 (PA-12), polyvinylidene difluoride (PVDF), or any combination thereof. Although a number of particular layers are depicted, it should be understood that the techniques described in the present disclosure may be broadly applicable to composite pipe body structures having two or more layers, for example, as distinguished from a rubber or plastic single-layer hose subject to vulcanization. In any case, as depicted, an inner surface 30 of the flexible pipe tubing 22 defines (e.g., encloses) a pipe bore 32 through which fluid can flow, for example, to facilitate transporting fluid from a bore fluid source 12 to a bore fluid destination 14.

Additionally, as depicted, the annulus 25 of the flexible pipe tubing 22 is defined between its inner barrier layer 26 and its outer barrier layer 28. As will be described in more detail below, the tubing annulus 25 may include one or more intermediate layers. Furthermore, as depicted, fluid conduits (e.g., free space and/or gaps) 24 running along the length of the flexible pipe 20 are defined (e.g., enclosed) in the tubing annulus 25. As described above, a fluid conduit 24 in the tubing annulus 25 of a flexible pipe 20 may be devoid of solid material. As such, pipe tubing 22 that includes one or more fluid conduits 24 defined in its annulus 25 may include less solid material and, thus, exert less resistance to flexure, for example, as compared to solid pipe tubing 22 and/or pipe tubing 22 that does not include fluid conduits 24 defined in its annulus 25. Moreover, to facilitate further improving pipe flexibility, in some embodiments, one or more tubing layers in a flexible pipe 20 may be unbonded from one or more other tubing layers and, thus, the flexible pipe 20 may be an unbonded pipe.

However, it should be appreciated that the depicted example is merely intended to be illustrative and not limiting. In particular, in other embodiments, a flexible pipe 20 may include fewer than two (e.g., one) or more that two (e.g., three, four, or more) fluid conduits 24 defined in its tubing annulus 25. Additionally, in other embodiments, a fluid conduit 24 defined in the tubing annulus 25 of a flexible pipe 20 may run non-parallel to the pipe bore 32 of the flexible pipe 20, for example, such that the fluid conduit 24 is skewed relative to the axial extent (e.g., longitudinal axis) of the pipe bore 32.

To help illustrate, an example of a portion 36 of a flexible pipe 20, which includes an inner barrier layer 26 and an intermediate layer 34 included in the annulus 25 of its pipe tubing 22, is shown in FIG. 3. In some embodiments, one or more intermediate layers 34 of the flexible pipe tubing 22 may formed from composite material and/or metal, such as carbon steel, stainless steel, duplex stainless steel, super duplex stainless steel, or any combination thereof. In other words, at least in some such embodiments, an intermediate layer 34 of the flexible pipe tubing 22 may be formed using electrically conductive material, which, at least in some instances, may enable communication of electrical (e.g., sensor and/or control) signals via the intermediate layer 34.

In any case, as depicted, the intermediate layer 34 includes a material strip 40, which is helically disposed (e.g., wound and/or wrapped) on the inner barrier layer 26 such that free space is left between adjacent windings to define a fluid conduit 24. In other words, in some embodiments, the intermediate layer 34 may be implemented at least in part by winding a material (e.g., metal and/or steel) strip 40 around the inner barrier layer 26 at a non-zero lay angle (e.g., fifty-two degrees) relative to the longitudinal extent 42 of the pipe bore 32. In any case, as depicted, the resulting fluid conduit 24 runs helically along the flexible pipe 20, for example, such that the fluid conduit 24 is skewed fifty-two degrees relative to the longitudinal extent 42 of the pipe bore 32.

In some embodiments, an outer barrier layer 28 may be disposed directly over the depicted intermediate layer 34 and, thus, cover and/or define (e.g., enclose) the depicted fluid conduit 24. However, in other embodiments, the tubing annulus 25 of a flexible pipe 20 may include multiple (e.g., two, three, four, or more) intermediate layers 34. In other words, in such embodiments, one or more other intermediate layers 34 may be disposed over the depicted intermediate layer 34. In fact, in some such embodiments, the one or more other intermediate layers 34 may also each be helically disposed such that free space is left between adjacent windings to implement one or more corresponding fluid conduits 24 in the tubing annulus 25 of the flexible pipe 20.

For example, a first other intermediate layer 34 may be helically disposed on the depicted intermediate layer 34 using the same non-zero lay angle as the depicted intermediate layer 34 to cover (e.g., define and/or enclose) the depicted fluid conduit 24 and to implement another fluid conduit 24 in the first other intermediate layer 34. Additionally, a second other intermediate layer 34 may be helically disposed on the first other intermediate layer 34 using another non-zero lay angle, which is the inverse of the non-zero lay angle of the depicted intermediate layer 34, to implement another fluid conduit 24 in the second other intermediate layer 34. Furthermore, a third other intermediate layer 34 may be helically disposed on the second other intermediate layer 34 using the same non-zero lay angle as the second other intermediate layer 34 to cover the other fluid conduit 24 in the second other intermediate layer 34 and to implement another fluid conduit 24 in the third other intermediate layer 34. In some embodiments, an outer barrier layer 28 may be disposed over the third other intermediate layer 34 and, thus, cover (e.g., define and/or enclose) the other fluid conduit 24 in the third other intermediate layer 34. In any case, as described above, in some instances, flexible pipe 20 may be formed (e.g., wound, wrapped, and/or spooled) into a pipe coil having a coil bore that extends axially therethrough, a first circular base, a second (e.g., opposite) circular base, and a cylindrical outer surface, for example, for transportation and/or storage before at least a segment 78 of the flexible pipe 20 is deployed from the pipe coil into a pipeline system 10.

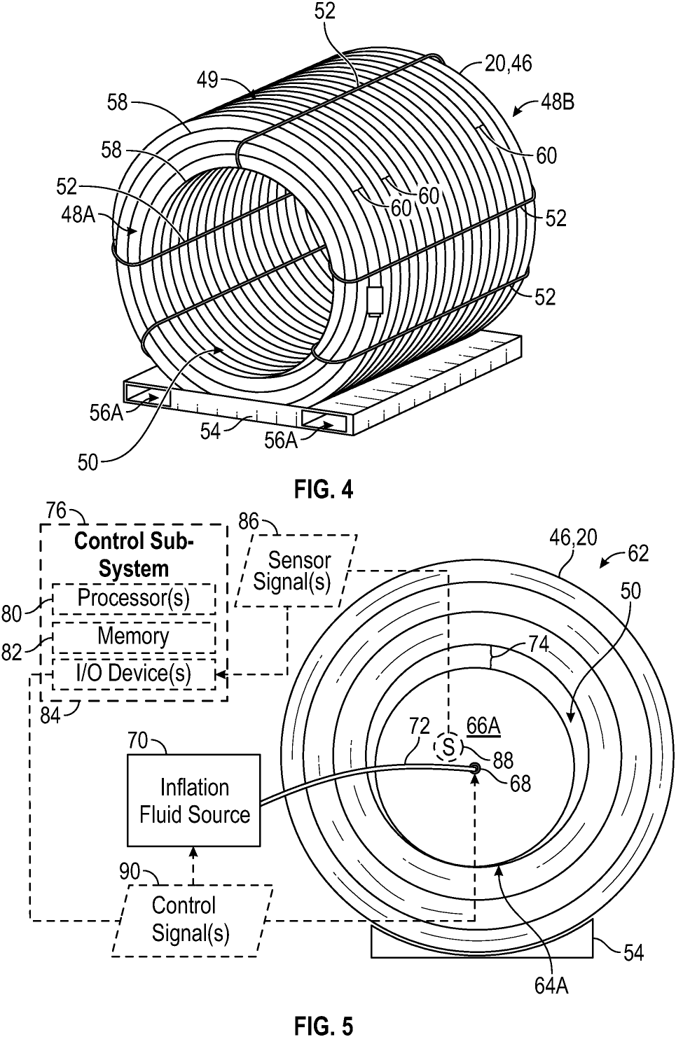

To help illustrate, an example of flexible pipe 20, which is formed into a pipe coil 46, is shown in FIG. 4. As depicted, a pipe coil 46 may generally be formed to include a first circular base 48A, a second (e.g., opposite) circular base 48B, a cylindrical outer surface 49, and a coil bore 50 that extends axially therethrough. In other words, as in the depicted example, a target shape of a pipe coil 46 may be an open cylindrical (e.g., tubular) shape that has circular ring-shaped ends (e.g., bases), for example, to enable the pipe coil 46 to rotate on pipe deployment equipment to facilitate deploying flexible pipe 20 from the pipe coil 46 directly into a pipeline system 10.

In fact, as in the depicted example, to facilitate maintaining a target shape of a pipe coil 46, in some embodiments, one or more straps 52 may be wrapped around the pipe coil 46. Additionally, in the depicted example, the pipe coil 46 is disposed on a pipe skid 54, which, although somewhat obfuscated from view, has a curved (e.g., rounded and/or concave) upper surface, for example, to facilitate retaining the pipe coil 46 on the pipe skid 54 and/or maintaining the target shape of the pipe coil 46. In particular, a pipe skid 54 may generally retain a pipe coil 46 thereon to facilitate storing and/or transporting the pipe coil 46. For example, to facilitate transporting a pipe coil 46 via a pipe transportation vehicle, such as a pipe transportation trailer, a pipe coil 46 may be retained on a pipe skid 54, which is loaded on the pipe transportation vehicle. In fact, as in the depicted example, to facilitate handling (e.g., transporting and/or moving) a pipe skid 54 and, thus, a pipe coil 46 loaded thereon via a forklift, in some embodiments, the pipe skid 54 may include forklift channels (e.g., pockets) 56A, which each accommodate a tine of the forklift.

However, it should be that the depicted example is merely intended to be illustrative and not limiting. In particular, in other embodiments, a pipe coil 46 may be formed to include more than four (e.g., five, six, or more) pipe layers 58 or fewer than four (e.g., three, two, or fewer) pipe layers 58. Additionally, in other embodiments, in other embodiments, a pipe layer 58 in a pipe coil 46 may be formed to include more than seventeen (e.g., eighteen, nineteen, or more) pipe wraps 60 or fewer than seventeen (e.g., sixteen, fifteen, or fewer) pipe wraps 60.

Furthermore, in other embodiments, a pipe skid 54 may not include forklift channels 56A and/or a curved upper surface. Alternatively, a pipe coil 46 may not be disposed on a pipe skid 54. For example, as will be described in more detail below, a pipe coil 46 may be disposed on pipe deployment equipment in a pipe handling system to facilitate deploying flexible pipe 20 from the pipe coil 46 directly into a pipeline system 10. Moreover, in other instances, a strap 52 may not be wrapped around a pipe coil 46.

Unfortunately, even when straps 52 are wrapped around a pipe coil 46, at least in some instances, force exerted on a pipe coil 46 may cause the pipe coil 46 to inadvertently deform from its target (e.g., open cylindrical) shape. For example, translational force resulting from translational movement (e.g., transportation) of a pipe coil 46 may cause the pipe coil 46 to lean to one side and/or to ovalize. Additionally or alternatively, downward force resulting from gravity may cause a pipe coil 46 to ovalize and/or to lean to one side, for example, due to pipe wraps 60 in the pipe coil 46 being skewed (e.g., not parallel and not perpendicular) relative to a central axis of the pipe coil 46.

As mentioned above, maintaining a target shape of a pipe coil 46 may facilitate deploying flexible pipe 20 from the pipe coil 46 into a pipeline system 10, for example, at least part by enabling the pipe coil 46 to rotate on pipe deployment equipment. Additionally, as mentioned above, in some instances, a pipe coil 46 may be loaded on a pipe transportation vehicle. At least in some such instances, when a pipe coil 46 loaded on a pipe transportation vehicle inadvertently leans to one side and, thus, deviates from its target shape, the pipe coil 46 may inadvertently extend horizontally beyond the pipe transportation vehicle.

Accordingly, to facilitate supporting and, thus, maintaining a target (e.g., open cylindrical) shape of a pipe coil 46, the present disclosure provides techniques for implementing and/or operating a pipe drum that may be selectively inserted (e.g., disposed) within the coil bore 50 of the pipe coil 46. In particular, to facilitate selectively selective insertion, the present disclosure provides techniques for implementing and/or operating an inflatable pipe drum, which has an adaptively (e.g., selectively) adjustable diameter. As will be described in more detail below, at least in some instances, using an inflatable pipe drum may facilitate improving pipeline deployment efficiency, for example, due to the inflatable pipe drum being able to be inserted into a coil bore 50 of a pipe coil 46 after the pipe coil 46 is initially formed and/or due to the inflatable pipe drum being suitable for supporting support pipe coils 46 that are formed from different diameter flexible pipe 20.

To help illustrate, an example of a system 62, which includes an example of an inflatable pipe drum 64A disposed within a coil bore 50 of a pipe coil 46, is shown in FIG. 5. As in the depicted example, to facilitate adaptively adjusting its diameter, an inflatable pipe drum 64 may generally include an inflatable drum bladder 66. In particular, in the depicted example, the inflatable drum bladder 66A of the inflatable pipe drum 64A has a closed cylindrical shape.

However, it should be appreciated that the depicted example is merely intended to be illustrative and not limiting. In particular, as will be described in more detail below, in other embodiments, an inflatable drum bladder 66 in an inflatable pipe drum 64 may have a different shape, such as an open cylindrical (e.g., tubular) shape, a rectangular prism shape, or a cylindrical segment shape, for example to enable a pipe lifting device to be inserted into the coil bore 50 of a corresponding pipe coil 46 and/or to enable the inflatable drum bladder 66 to be disposed circumferentially around a fixed drum core. In any case, an inflatable drum bladder 66 in an inflatable pipe drum 64 generally includes bladder walls that define one or more internal fluid cavities.

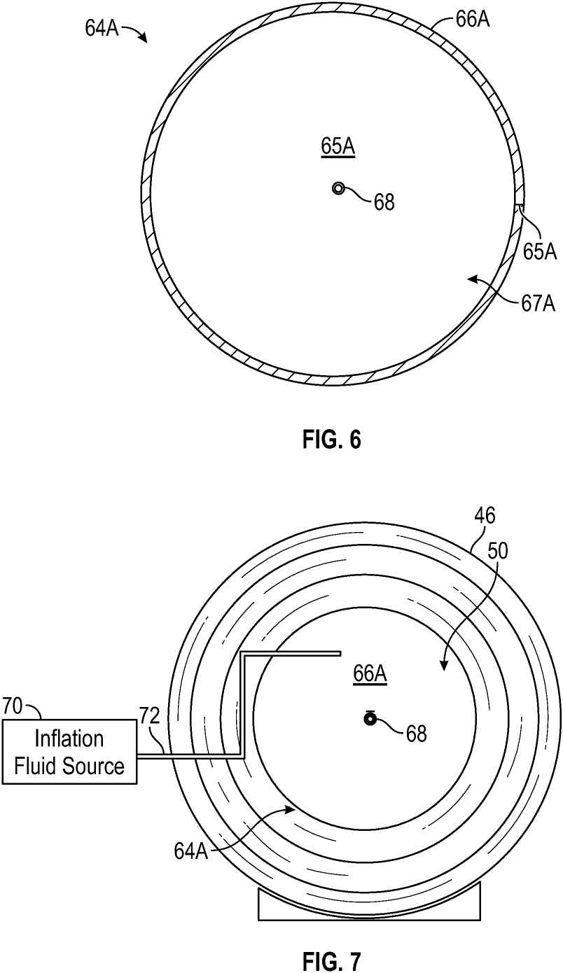

To help illustrate, a radial cross-section of an example of the inflatable pipe drum 64A is shown in FIG. 6. As depicted, an inflatable drum bladder 66 in an inflatable pipe drum generally includes bladder walls 65 that define one or more internal fluid cavities 67. In particular, in the depicted example, the inflatable drum bladder 66A includes bladder walls 65 -namely bladder side walls 65A - that define its shape and a single continuous internal fluid cavity 67A.

However, it should be appreciated that the depicted example is merely intended to be illustrative and not limiting. In particular, as will be described in more detail below, in addition to bladder side walls 65A, in some embodiments, an inflatable drum bladder 66 in an inflatable pipe drum 64 may include internal bladder walls 65, for example, to facilitate defining multiple separate internal fluid cavities 67 within the inflatable drum bladder 66

In any case, an inflatable drum bladder 66 in an inflatable pipe drum 64 generally expands radially outward when inflation fluid, such as compressed air, nitrogen gas, and/or water, is supplied to an internal fluid cavity 67 defined therein and generally contracts radially inward when inflation fluid is extracted (e.g., released) from the internal fluid cavity 67 defined therein. To facilitate controlling the amount of inflation fluid within an internal fluid cavity 67 of an inflatable drum bladder 66 and, thus, a corresponding inflation state, as depicted in FIGS. 5 and 6, an inflatable pipe drum 64 generally includes a fluid valve 68 secured the inflatable drum bladder 66 such that the fluid valve 68 opens through a bladder side wall 65A of the inflatable drum bladder 66 to the internal fluid cavity 67. Additionally, to facilitate supplying inflation fluid to and/or extracting of inflation fluid from an internal fluid cavity 67 defined in an inflatable drum bladder 66, an inflation fluid source 70, such as a fluid pump or a compressed air source, may be fluidly connected to a corresponding fluid valve 68 via one or more external fluid conduits 72, such as a hose.

However, it should again be appreciated that the depicted example is merely intended to be illustrative and not limiting. In particular, in other embodiments, an inflatable pipe drum 64 may include multiple fluid valves 68 fluidly connected to an internal fluid cavity 67 defined in an inflatable drum bladder 66. For example, in some such embodiments, a first fluid valve 68 connected to an internal fluid cavity 67 in an inflatable drum bladder 66 may be dedicated to supplying inflation fluid to the internal fluid cavity 67 while a second fluid valve 68 connected to the internal fluid cavity 67 may be dedicated to extracting inflation fluid from the internal fluid cavity 67.

In any case, FIG. 5 shows the inflatable drum bladder 66A of the inflatable pipe drum 64A in a less inflated (e.g., deflated) state in which open space 74 is present between the inflatable drum bladder 66A and the pipe coil 46. As such, an inflatable pipe drum 64 may generally be inserted into and/or withdrawn from a coil bore 50 in a pipe coil 46 when an inflatable drum bladder 66 of the inflatable pipe drum 64 is in its less inflated state. In fact, in some embodiments, this may facilitate improving pipeline deployment efficiency, for example, by enabling an inflatable pipe drum 64 to be inserted into and/or withdrawn from a coil bore 50 of pipe coil 46 after the pipe coil 46 is initially formed. Nevertheless, in other embodiments, flexible pipe 20 may be spooled (e.g., formed) directly on an inflatable pipe drum 64.

In any case, as described above, an inflatable drum bladder 66 in an inflatable pipe drum 64 generally expands radially outward when inflation fluid is supplied to an internal fluid cavity 67 defined therein. In other words, the diameter of an inflatable pipe drum 64 may generally dynamically increase when inflation fluid is supplied to an inflatable drum bladder 66 therein. Accordingly, to facilitate supporting the pipe coil 46 from within its coil bore 50 and, thus, maintaining a target (e.g., open cylindrical) shape of the pipe coil 46, the inflatable drum bladder 66A may be transitioned from its less inflated (e.g., deflated) state to a more (e.g., partially or fully) inflated state in which the inflatable drum bladder 66A is circumferentially compressed against the pipe coil 46.

To help more clearly illustrate, an example of the inflatable pipe drum 64A, which is disposed within a coil bore 50 of a pipe coil 46 while its inflatable drum bladder 66A is in its more (e.g., partially or fully) inflated state, is shown in FIG. 7. In particular, as depicted, while the inflatable drum bladder 66A is in its more inflated state, the inflatable drum bladder 66A circumferentially engages (e.g., directly abuts) an inner surface of the pipe coil 46 that defines its coil bore 50, thereby supporting the pipe coil 46 from within its coil bore 50 and, thus, reducing the likelihood that the pipe coil 46 inadvertently deforms from its target (e.g., open cylindrical) shape. Nevertheless, to facilitate increasing support provided to a pipe coil 46 and, thus, further reducing the likelihood that the pipe coil 46 inadvertently deforms from its target shape, in some embodiments, an inflatable drum bladder 66 may be transitioned to its more inflated state at least in part by continuing to supply inflation fluid to an internal fluid cavity 67 defined therein after the inflatable drum bladder 66 initially contacts the pipe coil 46, thereby compressing the inflatable drum bladder 66 against the pipe coil 46.

In fact, due to the ability to adaptively (e.g., dynamically) adjust its diameter, in some embodiments, an inflatable pipe drum 64 may be suitable for supporting pipe coils 46 that have different coil bore diameters and/or pipe coil 46 that are formed from different diameter flexible pipe 20, which, at least in some instances, may facilitate reducing pipeline deployment-associated cost, such as component count and/or physical footprint, for example, by obviating the use of multiple different pipe drums. In particular, to facilitate accounting for coil bore diameter differences, different amounts of inflation fluid may be supplied to an inflatable drum bladder 66 of an inflatable pipe drum 64 to transition the inflatable drum bladder 66 to its more inflated state when the inflatable pipe drum 64 is disposed within different pipe coils 46. For example, more inflation fluid may be supplied to the inflatable drum bladder 66 to transition the inflatable drum bladder 66 its more inflated state when the inflatable pipe drum 64 is disposed within a first pipe coil 46 that has a larger coil bore diameter while less inflation fluid may be supplied to the inflatable drum bladder 66 to transition the inflatable drum bladder 66 to its more inflated state when the inflatable pipe drum 64 is disposed within a second pipe coil 46 that has a smaller coil bore diameter.

In any case, as in the depicted example, after an inflatable drum bladder 66 of an inflatable pipe drum 64 is transitioned to its more inflated state, in some embodiments, a corresponding inflation fluid source 70 may be disconnected from the inflatable pipe drum 64, for example, at least in part by disconnecting an external fluid conduit 72, which is connected to the inflation fluid source 70, from a fluid valve 68, which is secured to the inflatable drum bladder 66. In fact, at least in some instances, disconnecting an inflation fluid source 70 from an inflatable drum bladder 66 of an inflatable pipe drum 64 after the inflatable drum bladder 66 has been transitioned to its more inflated state may facilitate reducing pipeline deployment-associated cost, such as component count and/or physical footprint, for example, at least in part by enabling the inflation fluid source 70 to be used with multiple different inflatable drum bladders 66 and/or by enabling the inflatable pipe drum 64 to be stored and/or transported independent of (e.g., without) the inflation fluid source 70. In any case, to facilitate maintaining an inflation state of an inflatable drum bladder 66 after an inflation fluid source 70 is disconnected, a corresponding fluid valve 68 may be transitioned from its open state (e.g., position) to its closed state (e.g., position) to block fluid from flowing into and/or out from a corresponding internal fluid cavity 67 in the inflatable drum bladder 66.

On the other hand, a fluid valve 68 connected to an inflatable drum bladder 66 in an inflatable pipe drum 64 may be transitioned from its closed state to its open state to enable inflation fluid to flow into and/or out from a corresponding internal fluid cavity 67 in the inflatable drum bladder 66. In particular, transitioning a fluid valve 68 to its open state may facilitate transitioning a corresponding inflatable drum bladder 66 toward its more inflated state at least in part by enabling an inflation fluid source 70 to supply inflation fluid to a corresponding internal fluid cavity 67. Additionally or alternatively, transitioning a fluid valve 68 to its open state may facilitate transitioning a corresponding inflatable drum bladder 66 toward its less inflated state at least in part by enabling inflation fluid to flow out from a corresponding internal fluid cavity 67, for example, back to an inflation fluid source 70 and/or to external environmental conditions.

In any case, in some embodiments, operation of a fluid valve 68 in an inflatable pipe drum 64 and/or operation of an inflation fluid source 70 that is fluidly connected to the inflatable pipe drum 64 may be manually controlled, for example, by an operator (e.g., user and/or service technician). However, in other embodiments, operation of a fluid valve 68 in an inflatable pipe drum 64 and/or operation of an inflation fluid source 70 that is fluidly connected to the inflatable pipe drum 64 may be automated. In particular, as in the example depicted in FIG. 5, to facilitate automating operation, in some embodiments, a control sub-system 76 may be communicatively coupled to a fluid valve 68 in an inflatable pipe drum 64 and/or an inflation fluid source 70 that is fluidly connected to the inflatable pipe drum 64, for example, via a wired connection and/or a wireless connection. In any case, as in the depicted example, a control sub-system 76 generally includes one or more processors 80, memory 82, and one or more input/output (I/O) devices 84.

In particular, in some embodiments, memory 82 in a control sub-system 76 may include one or more tangible, non-transitory, computer-readable media that are implemented and/or operated to store data and/or executable instructions. For example, memory 82 in a control sub-system 76 may store sensor data, which is indicative of the fluid pressure within an internal fluid cavity 67 in an inflatable drum bladder 66, based at least in part on one or more sensor signals 86 received from a corresponding fluid pressure sensor 88, for example, which is integrated with a corresponding fluid valve 68 or fluidly connected between the fluid valve 68 and a corresponding inflation fluid source 70. Additionally or alternatively, memory 82 in a control sub-system 76 may store sensor data, which is indicative of the fluid volume within an internal fluid cavity 67 in an inflatable drum bladder 66, based at least in part on one or more sensor signals 86 received from a corresponding flow meter 88, for example, which is integrated with a corresponding fluid valve 68 or fluidly connected between the fluid valve 68 and a corresponding inflation fluid source 70. Thus, in some embodiments, memory 82 in a control sub-system 76 may include volatile memory, such as random-access memory (RAM), and/or non-volatile memory, such as read-only memory (ROM), flash memory, a solid-state drive (SSD), a hard disk drive (HDD), or any combination thereof.

Additionally, in some embodiments, a processor 80 in a control sub-system 76 may include processing circuitry that is implemented and/or operated to process data and/or to execute instructions stored in memory 82. In other words, in some such embodiments, a processor 80 in a control sub-system 76 may include one or more general purpose microprocessors, one or more application specific integrated circuits (ASICs), one or more field programmable gate arrays (FPGAs), or any combination thereof. For example, a processor 80 in a control sub-system 76 may process sensor data, which is stored in memory 82 based at least in part on one or more sensor signals 86 received from a fluid parameter sensor 88, to determine a corresponding fluid parameter, such as fluid pressure or fluid volume, within a corresponding internal fluid cavity 67 in an inflatable drum bladder 66.

Additionally or alternatively, a processor 80 in a control sub-system 76 may execute instructions stored in memory 82 to determine one or more control (e.g., command) signals 90 that instruct a system 62 to perform corresponding control actions. For example, the control sub-system 76 may determine a control signal 90 that instructs a fluid valve 68 to transition from its open state to its closed state or vice versa. As another example, the control sub-system 76 may determine a control signal 90 that instructs an inflation fluid source 70 to supply inflation fluid to a corresponding inflatable drum bladder 66 or to extract inflation fluid from the inflatable drum bladder 66.

Furthermore, to enable communication outside of a control sub-system 76 (e.g., with a fluid valve 68, an inflation fluid source 70, and/or a fluid parameter sensor 88), in some embodiments, I/O devices 84 in a control sub-system 76 may include one or more input/output (I/O) ports (e.g., terminals). Additionally, to facilitate communicating information to an operator (e.g., user and/or service technician), in some embodiments, I/O devices 84 in a control sub-system 76 may include one or more user output devices, such as an electronic display that is implemented and/or operated to display a graphical user interface (GUI), for example, which provides a visual representation of the inflation state of and/or one or more fluid parameters in an internal fluid cavity 67 of an inflatable pipe drum 64. Furthermore, in some embodiments, I/O devices 84 in a control sub-system 76 may include one or more user input devices, such as a hard button, a soft button, a keyboard, a mouse, and/or the like, for example, to enable an operator (e.g., user and/or service technician) to instruct a system 62 to transition an internal fluid cavity 67 in an inflatable pipe drum 64 from its less inflated state towards its more inflated state or vice versa.

However, it should again be appreciated that the depicted example is merely intended to be illustrative and not limiting. In particular, in other embodiments, an inflatable pipe drum 64 may include multiple inflatable drum bladders 66, for example, to enable a pipe lifting device, which is to be used to move a pipe coil 46, to be inserted into the coil bore 50 of the pipe coil 46 while the inflatable pipe drum 64 continues supporting a remainder of the pipe coil 46. Additionally or alternatively, as mentioned above, in other embodiments, an inflatable drum bladder 66 in an inflatable pipe drum 64 may have a different shape, for example, when the inflatable pipe drum 64 includes multiple inflatable drum bladders 66.

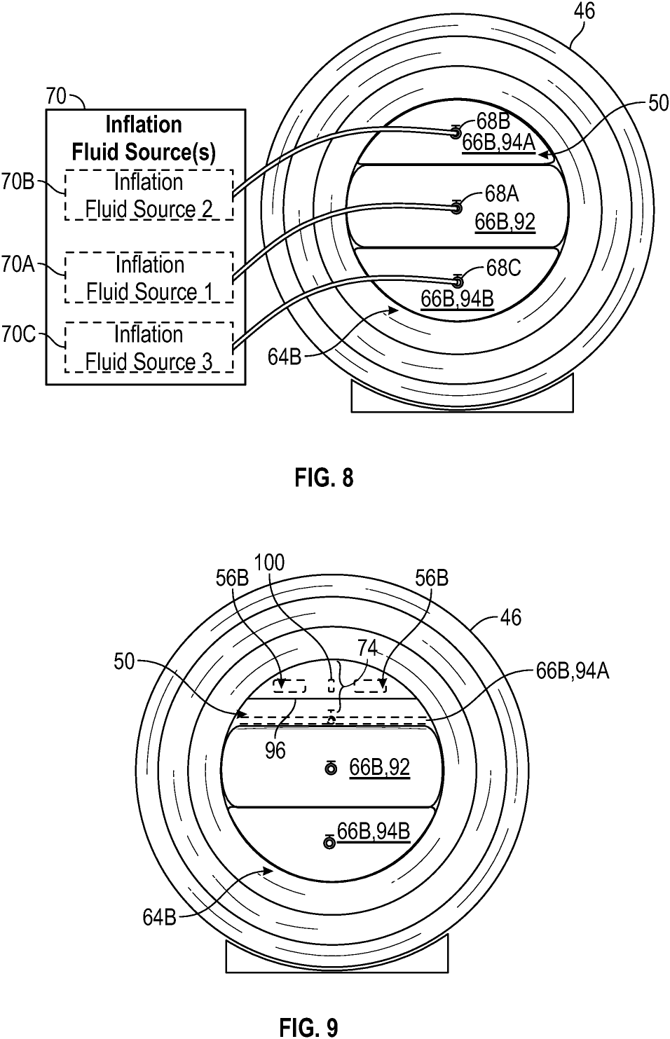

To help illustrate, another example of an inflatable pipe drum 64B, which is disposed within a coil bore 50 of a pipe coil 46, is shown in FIG. 8. Similar to the inflatable pipe drum 64A of FIGS. 5 and 7, the inflatable pipe drum 64B of FIG. 8 includes an inflatable drum bladder 66B - namely a central inflatable drum bladder 92 - and a first fluid valve 68A, which is secured to the central inflatable drum bladder 92 such that the first fluid valve 68A is fluidly connected to an internal fluid cavity 67 defined in the central inflatable drum bladder 92.

However, as depicted in FIG. 8, the inflatable pipe drum 64B include multiple inflatable drum bladders 66B. In particular, in addition to the central inflatable drum bladder 92, the inflatable drum bladder 66 includes side inflatable drum bladders 94 - namely a first side (e.g., top and/or upper) inflatable drum bladder 94A, which is disposed on a first side of (e.g., above) the central inflatable drum bladder 92 and has a second fluid valve 68B secured thereto such that the second fluid valve 68B is fluidly connected to an internal fluid cavity 67 defined therein, and a second side (e.g., bottom and/or lower) inflatable drum bladder 94B, which is disposed on a second side of (e.g., below) the central inflatable drum bladder 92 and has a third fluid valve 68C secured thereto such that the third fluid valve 68C is fluidly connected to an internal fluid cavity 67 defined therein. Additionally, as in the depicted example, in some embodiments, a central inflatable drum bladder 92 in an inflatable pipe drum 64 may have a rectangular prism shape while each side inflatable drum bladder 94 in the inflatable pipe drum 64 has a cylindrical segment shape.

Nevertheless, similar to FIG. 7, the inflatable pipe drum 64B of FIG. 8 circumferentially engages the pipe coil 46, thereby supporting the pipe coil 46 from within its coil bore 50 and, thus, reducing the likelihood of the pipe coil 46 inadvertently deforming from its target (e.g., open cylindrical) shape. In other words, in FIG. 8, the inflatable pipe drum 64B is shown with each of its inflatable drum bladders 66B in its more inflated state.

However, including multiple inflatable drum bladders 66 in an inflatable pipe drum 64 may enable the inflation states of the inflatable drum bladders 66 to be independently controlled. In fact, as in the depicted example, to facilitate independently and concurrently controlling the inflation states of multiple different inflatable drum bladders 66, in some embodiments, a different inflation fluid source (e.g., fluid pump and/or compressed air tank) 70 may be fluidly connected to each of the inflatable drum bladders 66. For example, a first inflation fluid source 70A may be fluidly connected to the first fluid valve 68A, which is fluidly connected to an internal fluid cavity 67 defined in the central inflatable drum bladder 92, a second inflation fluid source 70B may be fluidly connected to the second fluid valve 68B, which is fluidly connected to an internal fluid cavity 67 defined in the first side inflatable drum bladder 94A, and a third inflation fluid source 70C may be fluidly connected to the third fluid valve 68C, which is fluidly connected to an internal fluid cavity 67 defined in the second side inflatable drum bladder 94B.

Nevertheless, it should be appreciated that the depicted example is merely intended to be illustrative and not limiting. In particular, in other embodiments, the inflation states of multiple different inflatable drum bladders 66 may nevertheless be independently controlled by fluidly connecting the same inflation fluid source 70 to each of the inflatable drum bladders 66 at a different time (e.g., sequentially). In any case, in the depicted example, since the inflation state of the inflatable drum bladders 66B are independently controllable, in some embodiments, the first side inflatable drum bladder 94A of the inflatable pipe drum 64B may be transitioned from its more inflated state to its less inflated state to enable a pipe lifting device to be inserted into the coil bore 50 of the pipe coil 46 and, thus, used to move (e.g., lift and/or transport) the pipe coil 46, for example, in addition to the inflatable pipe drum 64B.

To help illustrate, an example of the inflatable pipe drum 64B, which is disposed within a coil bore 50 of a pipe coil 46 while its first side (e.g., upper and/or top) inflatable drum bladder 94A is in its less inflated (e.g., deflated) state, is shown in FIG. 9. Since an inflatable drum bladder 66 generally contracts radially inward when transitioned from its more inflated state to its more deflated state, as depicted, transitioning the first side inflatable drum bladder 94A to its less inflated state results in open space 74 being present between the pipe coil 46 and the inflatable pipe drum 64B. As depicted, to facilitate moving (e.g., lifting and/or transporting) the pipe coil 46, a pipe lifting device 96 may be disposed within the resulting open space 74 in the coil bore 50 of the pipe coil 46.

Nevertheless, similar to FIG. 8, in FIG. 9, the central inflatable drum bladder 92 and the second side inflatable drum bladder 94B of the inflatable pipe drum 64B are in their more (e.g., partially or fully) inflated states. In other words, in FIG. 9, the inflatable pipe drum 64B enables a pipe lifting device 96 to be used to move the pipe coil 46 while the inflatable pipe drum 64B continues supporting a remainder (e.g., majority) of the pipe coil 46.

However, it should be appreciated that the depicted example is merely intended to be illustrative and not limiting. In particular, in other embodiments, a central inflatable drum bladder 92 and one or more side inflatable drum bladders 94 of an inflatable pipe drum 64 may be combined into a single inflatable drum bladder 66, for example, which includes internal bladder walls 65 that divide the inflatable drum bladder 66 into multiple separate (e.g., fluidly isolated) internal fluid cavities 67. Additionally, in other embodiments, a side inflatable drum bladder 94 of an inflatable pipe drum 64 may be removed (e.g., withdrawn) from the coil bore 50 of a pipe coil 46 after the side inflatable drum bladder 94 is transitioned to its less inflated (e.g., deflated) state, for example, when the side inflatable drum bladder 94 is not secured (e.g., bonded and/or adhered) to a corresponding central inflatable drum bladder 92.

In any case, as in the depicted example, to facilitate reducing the likelihood of a pipe lifting device 96 inadvertently deforming a pipe coil 46, in some embodiments, the pipe lifting device 96 may include a curved (e.g., rounded and/or convex) upper surface, for example, in addition to a flat bottom surface to facilitate fitting the pipe lifting device 96 between a corresponding inflatable pipe drum 64 and the pipe coil 46. Additionally, as in the depicted example, to facilitate moving a pipe lifting device 96 and, thus, a corresponding pipe coil 46 via a forklift, in some embodiments, the pipe lifting device 96 may include forklift channels (e.g., pockets) 56B, which are each implemented (e.g., formed) to accommodate a tine of the forklift. Furthermore, as in the depicted example, to facilitate moving a pipe lifting device 96 and, thus, a corresponding pipe coil 46 via a crane, in some embodiments, the pipe lifting device 96 may include a pad eye 100 at either end to enable the pipe lifting device 96 to be secured to the crane via one or more lifting cables.

However, it should again be appreciated that the depicted example is merely intended to be illustrative and not limiting. In particular, in other embodiments, a pipe lifting device 96 may not include forklift channels 56B, for example, when the pipe lifting device 96 includes pad eyes 100. Additionally, in other embodiments, a pipe lifting device 96 may not include pad eyes 100, for example, when the pipe lifting device 96 includes forklift channels 56B. Furthermore, in other embodiments, an inflatable drum bladder 66 in an inflatable pipe drum 64 may be implemented with a different shape while nevertheless enabling a pipe lifting device 96 to be disposed within a coil bore 50 of a corresponding pipe coil 46.

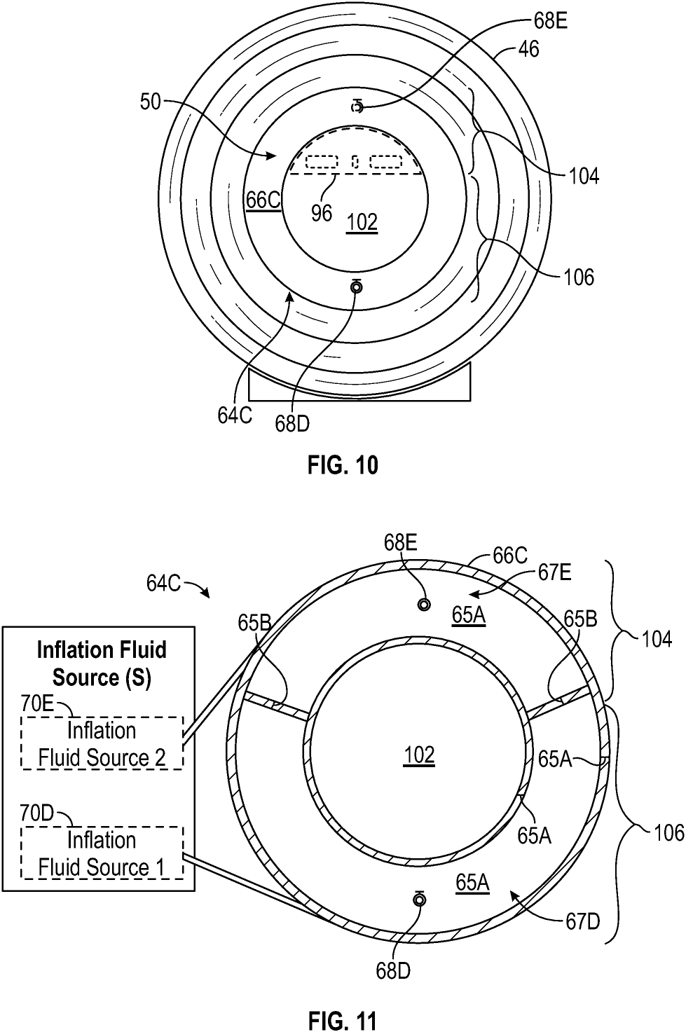

To help illustrate, a further example of an inflatable pipe drum 64C, which is disposed within a coil bore 50 of a pipe coil 46, is shown in FIG. 10. Similar to the inflatable pipe drums 64 of FIGS. 5 and 7-9, the inflatable pipe drum 64C of FIG. 10 includes an inflatable drum bladder 66C and a (e.g., first) fluid valve 68D, which is secured to the inflatable drum bladder 66C such that the fluid valve 68D is fluidly connected to an internal fluid cavity 67 defined within the inflatable drum bladder 66C. Additionally, similar to the inflatable pipe drums 64 of FIGS. 7 and 8, the inflatable pipe drum 64C of FIG. 10 circumferentially engages the pipe coil 46, thereby supporting the pipe coil 46 from within its coil bore 50 and, thus, reducing the likelihood that the pipe coil 46 inadvertently deforms from its target (e.g., open cylindrical) shape. In other words, in FIG. 10, the inflatable drum bladder 66C of the inflatable pipe drum 64C is in its more inflated state.

However, as depicted in FIG. 10, the inflatable drum bladder 66C of the inflatable pipe drum 64 has an open cylindrical shape, for example, instead of a closed cylindrical shape, a rectangular prism shape, or a cylindrical segment shape. In other words, as depicted, the inflatable drum bladder 66C defines a bladder bore 102 that extends axially therethrough. Thus, as in the depicted example, since the inflatable drum bladder 66C is disposed within the coil bore 50 of the pipe coil 46, in some embodiments, a pipe lifting device 96 may be disposed within the coil bore 50 of the pipe coil 46 at least in part by disposing the pipe lifting device 96 within the bladder bore 102 of the inflatable drum bladder 66C, thereby enabling the pipe lifting device 96 to be used to move (e.g., lift and/or transport) the pipe coil 46 while the inflatable drum bladder 66C continues circumferentially supporting the pipe coil 46.

However, since generally elastic to enable selective expansion and contraction, raising (e.g., lifting) a pipe coil 46 via a pipe lifting device 96 that is disposed within a bladder bore 102 of a corresponding inflatable drum bladder 66 may result in inflation fluid inadvertently being pushed from a top portion 104 of the inflatable drum bladder 66 to a bottom portion 106 of the inflatable drum bladder 66, thereby inadvertently deforming the inflatable drum bladder 66. In fact, to facilitate reducing the amount of inadvertent deformation, in some embodiments, bladder walls 65 of an inflatable drum bladder 66 may be formed (e.g., implemented) to define multiple separate internal fluid cavities 67 within the inflatable drum bladder 66.

To help illustrate, a radial cross-section of an example of the inflatable pipe drum 64C is shown in FIG. 11. Similar to the inflatable drum bladder 66A of FIG. 6, the inflatable drum bladder 66C in the inflatable pipe drum 64C of FIG. 11 includes bladder side walls 65A that define its shape.

However, as depicted in FIG. 11, in addition to bladder side walls 65A, the inflatable drum bladder 66C includes internal bladder walls 65B, which divide the inflatable drum bladder 66C into multiple separate (e.g., fluidly isolated) internal fluid cavities 67. In particular, in the depicted example, the internal bladder walls 65B of the inflatable drum bladder 66C divide the inflatable drum bladder 66C into a first (e.g., lower and/or bottom) internal fluid cavity 67D, which corresponds with a bottom portion 106 of the inflatable drum bladder 66C, and a second (e.g., upper and/or top) internal fluid cavity 67E, which corresponds with a top portion 104 of the inflatable drum bladder 66C. In other words, in the depicted example, the internal bladder walls 65B of the inflatable drum bladder 66C may facilitate blocking inadvertent fluid flow between the top portion 104 of the inflatable drum bladder 66C and the bottom portion 106 of the inflatable drum bladder and, thus, facilitate reducing the amount the inflatable drum bladder 66C is inadvertently deformed, for example, when a pipe lifting device 96 is used to lift a corresponding pipe coil 46 from within the bladder bore 102 of the inflatable drum bladder 66C.

Additionally, as in the depicted example, when an inflatable drum bladder 66 includes multiple internal fluid cavities 67, an inflatable pipe drum 64 may generally include multiple fluid valves 68, which are each secured to the inflatable drum bladder 66 such that it is fluidly connected to a corresponding internal fluid cavity 67 in the inflatable drum bladder 66. In particular, in the depicted example, to facilitate independently controlling the inflation states of the first internal fluid cavity 67D and the second internal fluid cavity 67E, the inflatable pipe drum 64C includes a first (e.g., lower and/or bottom) fluid valve 68D that is secured to the inflatable drum bladder 66C such that the fluid valve 68D opens through a bladder side wall 65A of the inflatable drum bladder 66C to the first internal fluid cavity 67D and a second (e.g., upper and/or top) fluid valve 68E that is secured to the inflatable drum bladder 66C such that the second fluid valve 68E opens through the bladder side wall 65A of the inflatable drum bladder 66C to the second internal fluid cavity 67E.

In fact, as in the depicted example, to facilitate independently and concurrently controlling the inflation states of multiple different internal fluid cavities 67 in an inflatable drum bladder 66, in some embodiments, a different inflation fluid source (e.g., fluid pump and/or compressed air tank) 70 may be fluidly connected to each of the internal fluid cavities 67. For example, a first inflation fluid source 70D may be fluidly connected to the first fluid valve 68D, which is fluidly connected to the first internal fluid cavity 67D in the inflatable drum bladder 66C, and a second inflation fluid source 70E may be fluidly connected to the second fluid valve 68E, which is fluidly connected to the second internal fluid cavity 67E in the inflatable drum bladder 66C.

However, it should be appreciated that the depicted example is merely intended to be illustrative and not limiting. In particular, in other embodiments, the inflation states of multiple different internal fluid cavities 67 in an inflatable drum bladder 66 may nevertheless be independently controlled by fluidly connecting the same inflation fluid source 70 to each of the internal fluid cavities 67 a different time (e.g., sequentially). Additionally, in other embodiments, an open cylindrical inflatable drum bladder 66 may be disposed circumferentially around a fixed drum core of an inflatable pipe drum 64 and, thus, its bladder bore 102 may not remain open.

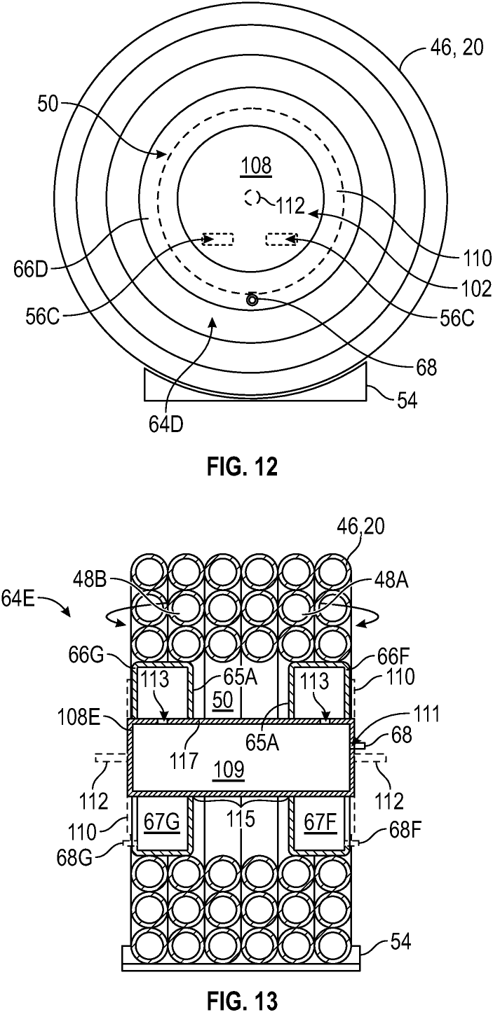

To help illustrate, another example of an inflatable pipe drum 64D, which is disposed within a coil bore 50 of a pipe coil 46, is shown in FIG. 12. Similar to the inflatable pipe drums 64 of FIGS. 5 and 7-10, the inflatable pipe drum 64D of FIG. 12 includes an inflatable drum bladder 66D and a fluid valve 68, which is secured to the inflatable drum bladder 66D such that the fluid valve 68 is fluidly connected to an internal fluid cavity 67 defined within the inflatable drum bladder 66D. In particular, similar to the inflatable drum bladder 66C of FIG. 10, the inflatable drum bladder 66D of FIG. 12 has an open cylindrical shape and, thus, defines a bladder bore 102.

However, as depicted in FIG. 12, the inflatable pipe drum 64D additionally includes a fixed drum core 108D disposed within the bladder bore 102 of the inflatable drum bladder 66D. In particular, whereas an inflatable drum bladder 66 may selectively expand and/or contract, a fixed drum core 108 in an inflatable pipe drum 64 may generally have fixed dimensions and, thus, a fixed diameter. Accordingly, the inflatable pipe drum 64D may nevertheless rely on the inflatable drum bladder 66D to adaptively adjust its diameter.

However, at least in some instances, including a fixed drum core 108 in an inflatable pipe drum 64 may facilitate increasing the amount of radial force an inflatable drum bladder 66 in the inflatable pipe drum 64 can exert on a corresponding pipe coil 46 and, thus, the amount of support the inflatable pipe drum 64 can provide to the pipe coil 46 due to the fixed drum core 108 providing a solid structure against which the inflatable drum bladder 66 can push. Additionally, as in the depicted example, to facilitate reducing inadvertent axial deformation of an inflatable drum bladder 66 and, thus, improving radial support the inflatable drum bladder 66 provides to a corresponding pipe coil 46 while the inflatable drum bladder 66 is in its more inflated state, in some embodiments, a fixed drum core 108 in an inflatable pipe drum 64 may include a support wing (e.g., plate and/or ring) 110, which extends radially outward from its body, secured at one or both axial ends of the inflatable drum bladder 66. In particular, in the depicted example, the inflatable pipe drum 64D includes a support wing 110 secured (e.g., welded) circumferentially around an end of the body its fixed drum core 108, which extends out axially beyond the inflatable drum bladder 66D, such that the support wing 110 extend radially outward at an axial end of the inflatable drum bladder 66D.

Nevertheless, it should be appreciated that the depicted example is merely intended to be illustrative and not limiting. In particular, in other embodiments, a fixed drum core 108 in an inflatable pipe drum 64 may not include a support wing 110. Furthermore, instead of having a closed cylindrical shape, in other embodiments, to facilitate reducing weight, a fixed drum core 108 in an inflatable pipe drum 64 may be hollow and, thus, include an open cylindrical rim, for example, in addition to core spokes connected across the open cylindrical rim to facilitate improving structural integrity. Additionally or alternatively, in other embodiments, an inflatable pipe drum 64 may include multiple inflatable drum bladders 66 axially offset along a fixed drum core 108, for example, such that an axial gap (e.g., open space) is present between neighboring inflatable drum bladders 66 to facilitate reducing weight of the inflatable pipe drum 64. Moreover, in other embodiments, a fluid valve 68 may be secured to a fixed drum core 108 of an inflatable pipe drum 64 such that the fluid valve 68 is fluidly connected to an internal fluid cavity 67 of an inflatable drum bladder 66, for example, to facilitate concurrently controlling inflation and/or deflation of multiple inflatable drum bladders 66 disposed axially along the fixed drum core 108.

To help illustrate, an axial cross-section of a further example of an inflatable pipe drum 64E, which is disposed within a coil bore 50 of a pipe coil 46, is shown in FIG. 13. Similar to the inflatable pipe drum 64D of FIG. 12, the inflatable pipe drum 64E of FIG. 13 includes a fixed drum core 108E and a first inflatable drum bladder 66F, which is disposed circumferentially around the fixed drum core 108E.

However, as depicted in FIG. 13, the inflatable pipe drum 64E additionally includes a second inflatable drum bladder 66G disposed circumferentially around the fixed drum core 108E such that the second inflatable drum bladder 66G is axially offset from the first inflatable drum bladder 66F. In particular, in the depicted example, the first inflatable drum bladder 66F radially supports at least the flexible pipe 20 that forms the first circular base 48A of the pipe coil 46 while the second inflatable drum bladder 66G radially supports at least the flexible pipe 20 that forms the second circular base 48B of the pipe coil 46. In fact, as in the depicted example, in some embodiments, inflatable drum bladders 66 of an inflatable pipe drum 64 may be disposed circumferentially around a corresponding fixed drum core 108 such that an axial gap (e.g., open space) 115 is present between the inflatable drum bladders 66, for example, to facilitate reducing weight and, thus, improving handling efficiency of the inflatable pipe drum 64.

Nevertheless, it should be appreciated that the depicted example is merely intended to be illustrative and not limiting. In particular, in other embodiments, inflatable drum bladders 66 of an inflatable pipe drum 64 may be disposed around a corresponding fixed drum core 108 such that the inflatable drum bladders 66 directly abut one another and, thus, an axial gap 115 is not present therebetween. Additionally or alternatively, in other embodiments, an inflatable pipe drum 64 may include more than two (e.g., three, four, or more) inflatable drum bladders 66 disposed around a fixed drum core 108.

Furthermore, in other embodiments, an inflatable drum bladder 66 of an inflatable pipe drum 64 may be axially recessed relative to both circular bases 48 of a corresponding pipe coil 46. Alternatively, in other embodiments, an inflatable drum bladder 66 of an inflatable pipe drum 64 may extend axially beyond a circular base 48 of a corresponding pipe coil 46. Moreover, as mentioned above, in other embodiments, a fixed drum core 108 in an inflatable pipe drum 64 may not include a support wing 110.

In any case, similar to the inflatable pipe drums 64 of FIGS. 5, 7-10, and 12, to facilitate controlling inflation and/or deflation of its inflatable drum bladders 66, the inflatable pipe drum 64E includes one or more fluid valves 68 that are fluidly connected to the internal fluid cavities 67 defined in the inflatable drum bladders 66. In particular, similar to FIGS. 5, 7-10, and 12, in some embodiments, a first fluid valve 68F may be secured directly to the first inflatable drum bladder 66F such that the first fluid valve 68F opens though a bladder side wall 65A of the first inflatable drum bladder 66F to a first internal fluid cavity 67F defined in the first inflatable drum bladder 66F while a second fluid valve 68G may be secured directly to the second inflatable drum bladder 66G such that the second fluid valve 68G opens through a bladder side wall 65A of the second inflatable drum bladder 66G to a second internal fluid cavity 67G defined in the second inflatable drum bladder 66G.

However, as in the depicted example, to facilitate concurrently (e.g., simultaneously) controlling inflation and/or deflation of multiple inflatable drum bladders 66, in some embodiments, a fluid valve 68 may be fluidly connected to each of the internal fluid cavities 67 defined within the inflatable drum bladders 66 via a corresponding fixed drum core 108. In particular, as in the depicted example, to facilitate fluidly connecting a fluid valve 68 to an internal fluid cavity 67 defined within an inflatable drum bladder 66 via a corresponding fixed drum core 108, in some embodiments, drum core walls 117 of the fixed drum core 108 may be formed to define an internal fluid passage 109, the internal fluid passage 109 may be fluidly connected to the internal fluid cavity 67 via a corresponding bladder opening (e.g., hole) 113 formed through a drum core wall 117, and the fluid valve 68 may be secured directly to the fixed drum core 108 such that the fluid valve 68 is fluidly connected to the internal fluid passage 109 via a valve opening (e.g., hole) 111 formed through a drum core wall 117, for example, instead of being secured directly to the inflatable drum bladder 66. Accordingly, in such embodiments, supplying inflation fluid to a single fluid valve 68 on an inflatable pipe drum 64 may facilitate concurrently inflating multiple inflatable drum bladders 66 while extracting inflation fluid from the fluid valve 68 may facilitate concurrently deflating the inflatable drum bladders 66.

Nevertheless, it should again be appreciated that the depicted example is merely intended to be illustrative and not limiting. In particular, to facilitate controlling inflation and/or deflation of multiple different inflatable drum bladders 66, in other embodiments, an inflatable pipe drum 64 may include multiple fluid valves 68 secured to its fixed drum core 108 and the fixed drum core 108 may define multiple different internal fluid passages 109, which each fluidly connects a corresponding valve opening 111 and, thus, a corresponding fluid valve 68 with a corresponding bladder opening 113 and, thus, an internal fluid cavity 67 defined in a corresponding inflatable drum bladder 66. Alternatively, in other embodiments, an inflatable pipe drum 64 that does not include a fixed drum core 108 may nevertheless include multiple axially offset inflatable drum bladders 66. Moreover, in other embodiments, a pipe coil 46 may not be disposed on a pipe skid 54, for example, instead being loaded on pipe deployment equipment that facilitates deploying flexible pipe 20 from the pipe coil 46 into a pipeline system 10.

In fact, as in the example depicted in FIG. 12, to facilitate moving an inflatable pipe drum 64 and, thus, a corresponding pipe coil 46 (e.g., between a pipe skid 54 and pipe deployment equipment), in some embodiments, a fixed drum core 108 of the inflatable pipe drum 64 may include forklift channels (e.g., pockets) 56C, which are each implemented to accommodate a tine of a forklift. In other words, in such embodiments, including a fixed drum core 108 in an inflatable pipe drum 64 may enable the inflatable pipe drum 64 and, thus, a corresponding pipe coil 46 to be moved (e.g., lifted and/or transported) without using a separate pipe lifting device 96. Additionally, as in the examples depicted in FIGS. 12 and 13, to facilitate rotating an inflatable pipe drum 64 and a corresponding pipe coil 46 on pipe deployment equipment and, thus, deploying flexible pipe 20 from the pipe coil 46, in some embodiments, the fixed drum core 108 of the inflatable pipe drum 64 may include drum shafts 112 that extend out axially from its body.

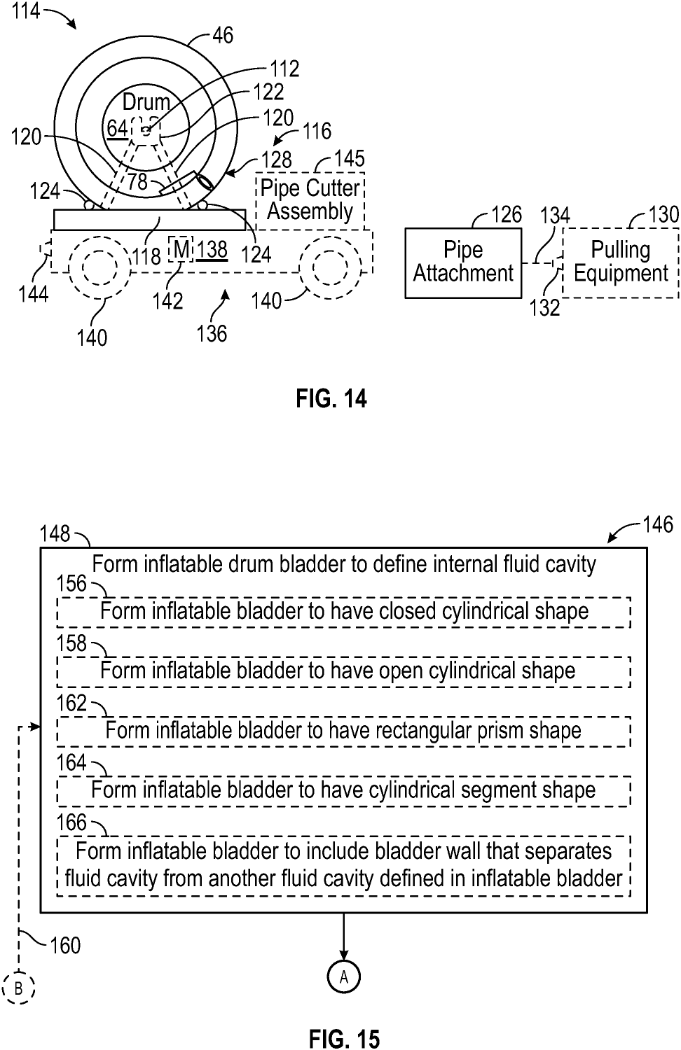

To help more clearly illustrate, an example of a pipe handling system 114, which includes pipe deployment equipment 116, is shown in FIG. 14. As depicted, a pipe coil 46, which is formed from flexible pipe 20, is disposed circumferentially around an inflatable pipe drum 64, for example, to facilitate maintaining a target (e.g., open cylindrical) shape of the pipe coil 46. In particular, the pipe coil 46 and the inflatable pipe drum 64 are loaded on the pipe deployment equipment 116 such that pipe coil 46 can rotate on the pipe deployment equipment 116.

Additionally, as depicted, pipe deployment equipment 116 in a pipe handling system 114 generally includes an equipment base 118. In particular, to facilitate rotating an inflatable pipe drum 64 thereon and, thus, unwinding flexible pipe 20 from a corresponding pipe coil 46, in some embodiments, pipe deployment equipment 116 may be a pipe deployment A-frame 116 and, thus, include support arms 120, which are secured to its equipment base 118, and shaft hubs 122, which are each secured to a pair of support arms 120 and implemented to interface (e.g., interlocks) with a drum shaft 112 of an inflatable pipe drum 64. Alternatively, to facilitate rotating an inflatable pipe drum 64 thereon and, thus, unwinding flexible pipe 20 from a corresponding pipe coil 46, in other embodiments, pipe deployment equipment 116 may be a pipe deployment cradle frame 116 and, thus, include rollers 124, which are rotatably secured to its equipment base 118 and implemented (e.g., formed) to engage an outer surface of the pipe coil 46 and/or a drum flange connected to a fixed drum core 108 of the inflatable pipe drum 64.

In any case, as depicted, to facilitate deploying flexible pipe 20 from an inflatable pipe drum 64 loaded on pipe deployment equipment 116, a pipe handling system 114 additionally generally includes a pipe attachment 126, which is implemented to be secured to an outboard (e.g., outer, free, and/or loose) end 128 of the flexible pipe 20. In particular, in some embodiments, a pipe attachment 126 in a pipe handling system 114 may be a pipe pull head 126, which is to be secured to an outboard end 128 of the flexible pipe 20 to enable the outboard end 128 of the flexible pipe 20 to be pulled away from a pipe deployment equipment 116 and, thus, a corresponding inflatable pipe drum 64. To facilitate moving (e.g., pulling and/or towing) a pipe pull head 126, in such embodiments, a pipe handling system 114 may additionally include pulling equipment 130, such as a bulldozer or a tow truck, that can be secured to the pipe pull head 126. In particular, to enable pulling equipment 130 to move a pipe pull head 126, in some such embodiments, the pipe pull head 126 may be secured to a hitch assembly 132 on the pulling equipment 130 via one or more pulling cables 134.

However, in other embodiments, a pipe attachment 126 in a pipe handling system 114 may be a pipe anchor 126, which is to be secured to the outboard end 128 of a flexible pipe 20 to facilitate holding (e.g., anchoring) the outboard end 128 of the flexible pipe 20 in place. Accordingly, in such embodiments, a pipe handling system 114 may unwind flexible pipe 20 from an inflatable pipe drum 64, which is loaded on pipe deployment equipment 116, at least in part by securing a pipe anchor 126 to the outboard end 128 of the flexible pipe 20 and moving (e.g., driving or pulling) the pipe deployment equipment 116 and, thus, the inflatable pipe drum 64 away from the pipe anchor 126 and, thus, the outboard end 128 of the flexible pipe 20. As in the depicted example, to facilitate moving an inflatable pipe drum 64 and a pipe coil 46 loaded on pipe deployment equipment 116, in some embodiments, the pipe deployment equipment 116 may be loaded on a pipe handling vehicle 136, which includes a vehicle frame 138 and vehicle wheels 140 rotatably secured to the vehicle frame 138.

In particular, in some embodiments, a pipe handling vehicle 136 in a pipe handling system 114 may include a motor (e.g., internal combustion engine) 142 connected to its vehicle wheels 140 and, thus, the pipe handling vehicle 135 may be self-propelled, thereby enabling the pipe handling vehicle 136 to drive itself and, thus, an inflatable pipe drum 64 loaded thereon, for example, away from a corresponding pipe anchor 126 and/or to a target pipe deployment location. However, in other embodiments, a pipe handling vehicle 136, such as a pipe handling trailer 136, in a pipe handling system 114 may not be self-propelled. Accordingly, to facilitate movement, in such embodiments, a pipe handling vehicle 136 may additionally include a tongue assembly 144, which is secured to its vehicle frame 138 and implemented to interlock with a hitch assembly 132 of pulling equipment 130, such as a tow truck.

However, it should be appreciated that the depicted example is merely intended to be illustrative and not limiting. In particular, in other embodiments, pipe deployment equipment 116 in a pipe handling system 114 may include equipment wheels rotatably secured directly to its equipment base 118, for example, to facilitate moving an inflatable pipe drum 64 and, thus, a pipe coil 46 loaded thereon to and/or from a target pipe deployment location in a pipeline system 10 (e.g., over a road). Additionally, in other embodiments, a pipe handling system 114 may not include a pipe handling vehicle 136, for example, when pipe deployment equipment 116 includes equipment wheels rotatably secured directly to its equipment base 118.

In any case, in some instances, the entire length of a flexible pipe 20, which is formed into a pipe coil 46 disposed on an inflatable pipe drum 64, may be continuously deployed (e.g., unwound, unwrapped, and/or unspooled) from the inflatable pipe drum 64 into a pipeline system 10. However, in other instances, only a segment (e.g., portion and/or section) 78 of a flexible pipe 20, which is formed into a pipe coil 46 disposed on an inflatable pipe drum 64, may be deployed in a pipeline system 10 at one time. To facilitate deploying a segment 78 of a flexible pipe 20 into a pipeline system 10, in some embodiments, a pipe handling system 114 may additionally include a pipe cutter assembly 145, for example, secured on a vehicle frame 138 of a pipe handling vehicle 136. In particular, a pipe cutter assembly 145 in a pipe handling system 114 may generally include a cutting blade, which can be selectively engaged with the tubing 22 of a flexible pipe 20 to facilitate cutting a segment 78 of the flexible pipe 20, which has been unwound from a corresponding pipe coil 46 and, thus, a corresponding inflatable pipe drum 64, off from a remainder of the flexible pipe 20.

However, it should again be appreciated that the depicted example is merely intended to be illustrative and not limiting. In particular, in other embodiments, a pipe handling system 114 may not include a pipe cutter assembly 145, for example, when the entire length of a flexible pipe 20, which is formed into a pipe coil 46 disposed on an inflatable pipe drum 64, is to be continuously deployed in a pipeline system 10. In any case, in this manner, the present disclosure provides techniques for implementing and/or operating an inflatable pipe drum 64 to facilitate supporting a pipe coil 46 from within its coil bore 50 and, thus, maintaining a target (e.g., open cylindrical) shape of the pipe coil 46, which, at least in some instances, may facilitate deploying flexible pipe 20 from the pipe coil 46 (e.g., by facilitating rotation of the pipe coil 46 on corresponding pipe deployment equipment 116), and/or transportation of the pipe coil 46 (e.g., by blocking the pipe coil 46 from inadvertently leaning beyond a boundary of a corresponding pipe skid 54 and/or a corresponding pipe handling vehicle 136).

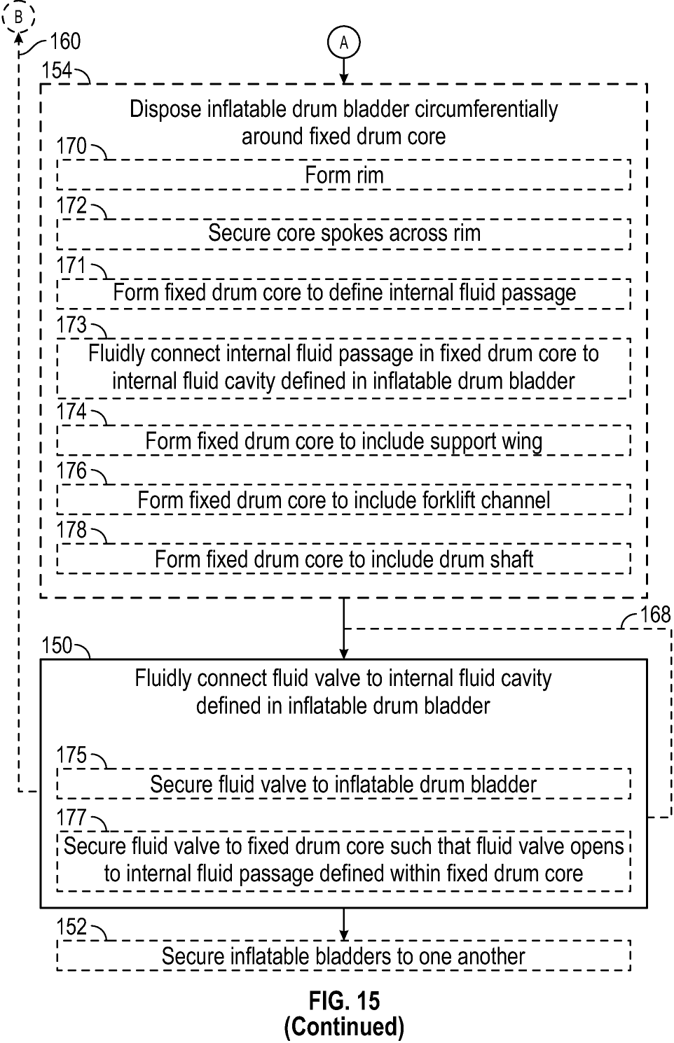

To help further illustrate, an example of a process 146 for implementing (e.g., manufacturing) an inflatable pipe drum 64 is described in FIG. 15. Generally, the process 146 includes forming an inflatable drum bladder to define an internal fluid cavity (process block 148). Additionally, the process 146 generally includes fluidly connecting a fluid valve to the internal fluid cavity defined in the inflatable drum bladder (process block 150).

Although specific process blocks are described in a specific order, which corresponds with an embodiment of the present disclosure, it should be appreciated that the depicted example is merely intended to be illustrative and not limiting. In particular, in other embodiments, a process 146 for implementing an inflatable pipe drum 64 may include one or more additional process blocks. For example, some embodiments of the process 146 may additionally include disposing the inflatable drum bladder circumferentially around a fixed drum core (process block 154) while other embodiments of the process 146 do not. As another example, some embodiments of the process 146 may additionally include securing inflatable drum bladders to one another (process block 152) while other embodiments of the process 146 do not.

In any case, as described above, to facilitate selectively supporting and, thus, maintaining a target (e.g., open cylindrical) shape of a pipe coil 46, an inflatable pipe drum 64 generally includes one or more inflatable drum bladders 66, which are to be disposed within a coil bore 50 of the pipe coil 46. In particular, as described above, to facilitate selectively supporting a pipe coil 46, an inflatable drum bladder 66 in an inflatable pipe drum 64 generally includes bladder walls 65, which are formed (e.g., implemented and/or molded) define one or more internal fluid cavities 67 such that the inflatable drum bladder 66 expands radially outward when inflation fluid, such as nitrogen gas, water, and/or compressed air, is supplied to its one or more internal fluid cavities 67 and the inflatable drum bladder 66 contracts radially inward when inflation fluid is extracted (e.g., released) from its one or more internal fluid cavities 67. Accordingly, implementing an inflatable pipe drum 64 may generally include forming (e.g., implementing and/or molding) bladder walls 65 of an inflatable drum bladder 66 to define one or more internal fluid cavities 67 within the inflatable drum bladder 66. In particular, to enable an inflatable drum bladder 66 to selectively expand and contract, in some embodiments, bladder walls 65 of the inflatable drum bladder 66 may be formed at least in part using elastic material, such as rubber.

Additionally, as described above, to enable an inflatable drum bladder 66 to circumferentially engage and, thus, circumferentially support a pipe coil 46, in some embodiments, bladder side walls 65A of the inflatable drum bladder 66 may be formed to define the inflatable drum bladder 66 with a cylindrical shape. In particular, as described with regard to FIGS. 5-7, in some such embodiments, bladder side walls 65A of an inflatable drum bladder 66 may be formed to define the inflatable drum bladder 66 with a closed cylindrical shape (process block 156). However, as described with regard to FIGS. 10-12, in other such embodiments, bladder side walls 65A of an inflatable drum bladder 66 may be formed to define the inflatable drum bladder 66 with an open cylindrical (e.g., tubular) shape, for example, to enable a pipe lifting device 96 to be inserted into a bladder bore 102 of the inflatable drum bladder 66 and/or the inflatable drum bladder 66 to be disposed circumferentially around a fixed drum core 108 (process block 158).

In any case, as described above, to facilitate controlling the amount of inflation fluid within an internal fluid cavity 67 of an inflatable drum bladder 66 and, thus, a corresponding inflation state, a fluid valve 68 may be fluidly connected to the internal fluid cavity 67 of the inflatable drum bladder 66 (process block 150). In particular, as described above, in some embodiments, a fluid valve 68 may be secured to a bladder side wall 65A of the inflatable drum bladder 66 such that the fluid valve 68 opens through the bladder side wall 65A to the internal fluid cavity 67 (process block 175). For example, in some such embodiments, a fluid valve 68 may be secured to an inflatable drum bladder 66 at least in part by bonding (e.g., adhering) the fluid valve 68 to a bladder side wall 65A of the inflatable drum bladder 66. Additionally or alternatively, a fluid valve 68 may be secured to an inflatable drum bladder 66 at least in part by threadingly engaging threads on the fluid valve 68 with a threaded valve opening formed through a bladder side wall 65A of the inflatable drum bladder 66 and/or partially embedding the fluid valve 68 within the bladder side wall 65A. In any case, in this manner, the present disclosure provides techniques for implementing an inflatable pipe drum 64 to enable an inflatable drum bladder 66 of the inflatable pipe drum 64 to circumferentially engage a corresponding pipe coil 46, which, at least in some instances, facilitates supporting the pipe coil 46 from within its coil bore 50 and, thus, maintaining a target (e.g., open cylindrical) shape of the pipe coil 46.

However, as described above, in other embodiments, an inflatable pipe drum 64 may circumferentially support a pipe coil 46 using multiple inflatable drum bladders 66, for example, to enable a pipe lifting device 96 to be selectively disposed within a coil bore 50 of the pipe coil 46. Accordingly, in such embodiments, implementing an inflatable pipe drum 64 may additionally include forming another inflatable drum bladder 66 to define another internal fluid cavity 67 and fluidly connecting a fluid valve 68 to the other internal fluid cavity 67 (arrow 160). In particular, as described with regard to FIGS. 8 and 9, in some such embodiments, an inflatable pipe drum 64 may include a central inflatable drum bladder 92, which has a rectangular prism shape, as well as a first side (e.g., top and/or upper) inflatable drum bladder 94A and a second side (e.g., bottom and/or lower) inflatable drum bladder 94B, which each has a cylindrical segment shape. Accordingly, in such embodiments, forming an inflatable drum bladder 66 may include forming bladder side walls 65A of the inflatable drum bladder 66 to define the inflatable drum bladder 66 with a rectangular prism shape (process block 162) or forming the bladder side walls 65A of the inflatable drum bladder 66 to define the inflatable drum bladder 66 with a cylindrical segment shape (process block 164).

Additionally, as described above, in some embodiments, inflatable drum bladders 66 in an inflatable pipe drum 64 may be secured to one another (process block 152). In particular, in such embodiments, inflatable drum bladders 66 may be secured to one another at least in part by bonding (e.g., adhering) a bladder side wall 65A of one inflatable drum bladder 66 to an adjacent bladder side wall 65A of another inflatable drum bladder 66. However, in other embodiments, adjacent bladder side walls 65A of different inflatable drum bladders 66 in an inflatable pipe drum 64 may not be secured to one another, for example, to enable a first side inflatable drum bladder 94A that is transitioned to its less inflated (e.g., deflated) state to be withdrawn from a coil bore 50 of a corresponding pipe coil 46 while a central inflatable drum bladder 92 and a second side inflatable drum bladder 94B, which are maintained in their more (e.g., partially or fully) inflated states, remain within the coil bore 50, thereby providing more open space 74 within the coil bore 50 for insertion of a pipe lifting device 96 while the central inflatable drum bladder 92 and the second side inflatable drum bladder 94B continue supporting a remainder of the pipe coil 46.

However, as described above, in addition to bladder side walls 65A that define its general shape, in some embodiments, an inflatable drum bladder 66 in an inflatable pipe drum 64 may include internal bladder walls 65B, which are formed (e.g., implemented and/or molded) to divide the inflatable drum bladder 66 into multiple separate (e.g., fluidly isolated) internal fluid cavities 67, for example, instead of including multiple separate inflatable drum bladders 66 in the inflatable pipe drum 64. In other words, in such embodiments, forming an inflatable drum bladder 66 may include forming (e.g., molding) internal bladder walls 65B of the inflatable drum bladder 66 to divide the inflatable drum bladder 66 into multiple separate internal fluid cavities 67 (process block 166). Additionally, as described above, to facilitate independently controlling the inflation states of multiple internal fluid cavities 67 within an inflatable drum bladder 66, in some embodiments, multiple fluid valves 68 may each be fluidly connected to a corresponding internal fluid cavity 67 in the inflatable drum bladder 66 (arrow 168). Merely as an illustrative non-limiting example, with regard to FIGS. 8 and 9, in other embodiments, an inflatable pipe drum 64 may instead include a single inflatable drum bladder 66 that includes bladder side walls 65A, which define a closed cylindrical shape, and internal bladder walls 65B, which divide the inflatable drum bladder 66 into a first (e.g., upper and/or top) cylindrical segment internal fluid cavity 67, a central rectangular prism internal fluid cavity 67, and a second (e.g., bottom and/or lower) cylindrical segment internal fluid cavity 67. Furthermore, as described with regard to FIG. 11, in some embodiments, an inflatable drum bladder 66 may include internal bladder walls 65B that divide the inflatable drum bladder 66 into a first (e.g., lower and/or bottom) internal fluid cavity 67D, which corresponds with a bottom portion 106 of the inflatable drum bladder 66, and a second (e.g., upper and/or top) internal fluid cavity 67E, which corresponds with a top portion 104 of the inflatable drum bladder 66, for example, to facilitate reducing the amount the inflatable drum bladder 66 is inadvertently deformed when a pipe lifting device 96 is used to lift a corresponding pipe coil 46 from within a bladder bore 102 of the inflatable drum bladder 66.

However, as described above, in other embodiments, a fixed drum core 108, which has fixed dimensions, may be disposed within a bladder bore 102 of an inflatable drum bladder 66. In other words, in such embodiments, implementing an inflatable pipe drum 64 may include disposing an inflatable drum bladder 66 circumferentially around a fixed drum core 108 (process block 154). In particular, at least in some instances, disposing an inflatable drum bladder 66 circumferentially around a fixed drum core 108 may provide a solid structure against which the inflatable drum bladder 66 can push and, thus, facilitate improving the ability of an inflatable pipe drum 64 to support a pipe coil 46. Accordingly, in some embodiments, a fixed drum core 108 in an inflatable pipe drum 64 may be formed (e.g., implemented, molded, milled, cast, and/or forged) at least in part using metal, such as carbon steel, stainless steel, duplex stainless steel, super duplex stainless steel, or any combination thereof.

Additionally, in some embodiments, a fixed drum core 108 of an inflatable pipe drum 64 may formed to have a closed cylindrical shape. In particular, as described with regard to FIG. 13, in some such embodiments, drum core walls 117 of a fixed drum core 108 may be formed (e.g., implemented and/or manufactured) to define an internal fluid passage 109 (process block 171), an inflatable drum bladder 66 may be disposed around the fixed drum core 108 such that an internal fluid cavity 67 of the inflatable drum bladder 66 is fluidly connected to the internal fluid passage 109 via a corresponding bladder opening 113 formed (e.g., implemented, milled, and/or drilled) through a drum core wall 117 (process block 173), and a fluid valve 68 may be secured to a drum core wall 117 such that the fluid valve 68 is fluidly connected to the internal fluid passage 109 via a corresponding valve opening 111 formed (e.g., implemented, milled, and/or drilled) through a drum core wall 117, for example, to enable inflation and/or deflation of the inflatable drum bladder 66 to be controlled concurrently with one or more other inflatable drum bladders disposed around the fixed drum core 108 (process block 177). However, as described with regard to FIG. 12, in other such embodiments, despite being disposed around a fixed drum core 108 that has a closed cylindrical shape, an inflatable drum bladder 66 may have a fluid valve 68 secured directly thereto to facilitate controlling its inflation and/or deflation.

Moreover, as described above, to facilitate reducing weight, in other embodiments, a fixed drum core 108 of an inflatable pipe drum 64 may be hollow. Accordingly, in such embodiments, forming a fixed drum core 108 of an inflatable pipe drum 64 may include forming (e.g., implementing, molding, milling, casting, and/or forging) an open cylindrical rim (process block 170). Furthermore, as described above, to facilitate improving structural rigidity, in some such embodiments, core spokes may be secured across an open cylindrical rim of a fixed drum core 108 (process block 172).

In any case, as described with regard to FIGS. 12 and 13, in some embodiments, a fixed drum core 108 of an inflatable pipe drum 64 may be formed to include a support wing (e.g., plate and/or ring) 110, which extends radially outward from its body at an axial end of a corresponding inflatable drum bladder 66, for example, to facilitate reducing inadvertent axial deformation of the inflatable drum bladder 66 and, thus, improving radial support the inflatable drum bladder provides to a corresponding pipe coil 46 while the inflatable drum bladder 66 is in its more inflated state (process block 174). In particular, as described above, in some such embodiments, a support wing 110 may be secured circumferentially around an end of a fixed drum core 108, which extends out axially beyond a corresponding inflatable drum bladder 66, such that the support wing 110 extends radially outward and, thus, is disposed at an axial end of the inflatable drum bladder 66.

Additionally, as described with regard to FIG. 12, in some embodiments, a fixed drum core 108 of an inflatable pipe drum 64 may be formed to include forklift channels (e.g., pockets) 56C, which each accommodate a tine of a forklift to enable a forklift to move the inflatable pipe drum 64 and, thus, a corresponding pipe coil 46, for example, between a pipe skid 54 and pipe deployment equipment 116 (process block 176). In fact, as described with regard to FIGS. 12 and 13, to facilitate rotating an inflatable pipe drum 64 on pipe deployment equipment 116 and, thus, deploying flexible pipe 20, in some embodiments, a fixed drum core 108 of the inflatable pipe drum 64 may be formed to include drum shafts 112, which extend out axially from its body and are implemented to interlock with shaft hubs 122 on the pipe deployment equipment 116 (process block 178). In any case, in this manner, an inflatable pipe drum 64 may be implemented to enable the inflatable pipe drum 64 to be used to facilitate supporting a pipe coil 46 and, thus, maintaining a target (e.g., open cylindrical) shape of the pipe coil 46, which, at least in some instances, may facilitate deploying flexible pipe 20 from the pipe coil 46 (e.g., by facilitating rotation of the pipe coil 46 on corresponding pipe deployment equipment 116), and/or transportation of the pipe coil 46 (e.g., by blocking the pipe coil 46 from inadvertently leaning beyond a boundary of a corresponding pipe skid 54 and/or a corresponding pipe handling vehicle 136).

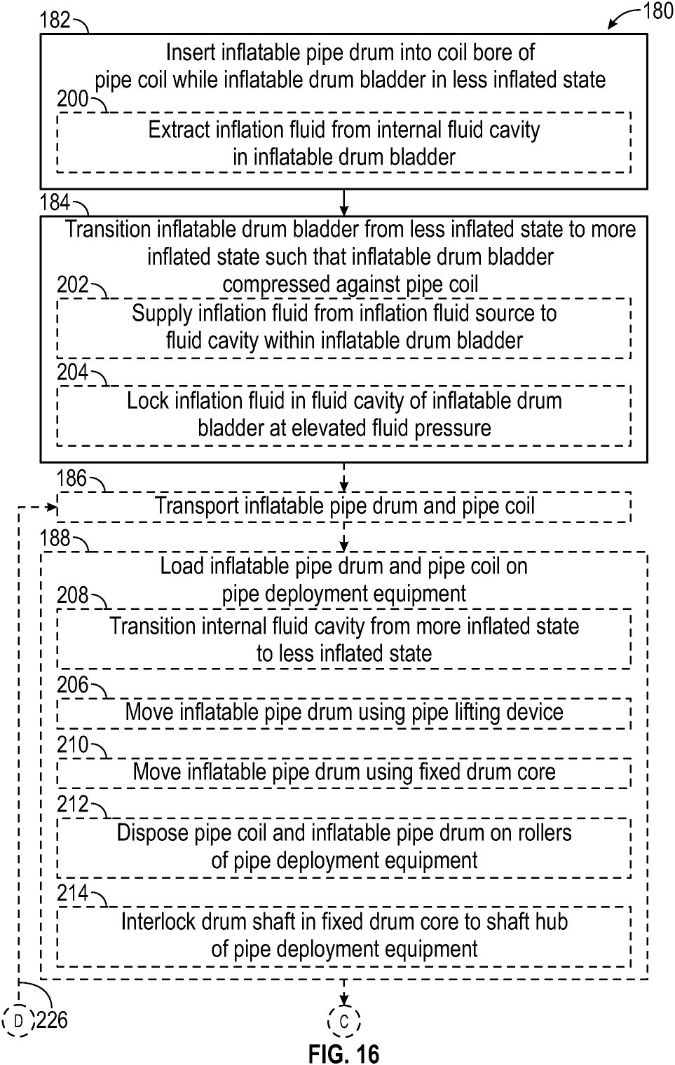

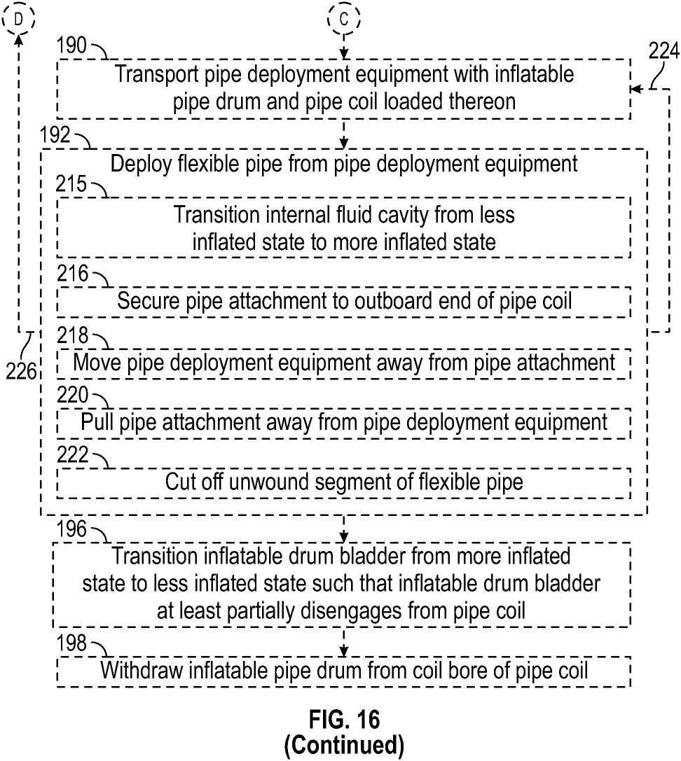

To help further illustrate, an example of a process 180 for operating (e.g., using) an inflatable pipe drum 64 is described in FIG. 16. Generally, the process 180 includes inserting an inflatable pipe drum into a coil bore of a pipe coil while an inflatable drum bladder is in a less inflated state (process block 182). Additionally, the process 180 generally includes transitioning the inflatable drum bladder from the less inflated state to a more inflated state such that the inflatable drum bladder is compressed against the pipe coil (process block 184).

Although specific process blocks are described in a specific order, which corresponds with an embodiment of the present disclosure, it should be appreciated that the example process 180 is merely intended to be illustrative and not limiting. In particular, in other embodiments, a process 180 for operating an inflatable pipe drum 64 may include one or more additional process blocks. For example, some embodiments of the process 180 may additionally include transporting the inflatable pipe drum and the pipe coil (process block 186) while other embodiments of the process do not.

As another example, some embodiments of the process 180 may additionally include loading the inflatable pipe drum and the pipe coil on pipe deployment equipment (process block 188) and deploying flexible pipe from the pipe deployment equipment (process block 192) while other embodiments of the process 180 do not. As a further example, some embodiments of the process 180 may additionally include transporting the pipe deployment equipment with the inflatable pipe drum and the pipe coil loaded thereon (process block 190) while other embodiments of the process 180 do not. As another example, some embodiments of the process 180 may additionally include transitioning the inflatable drum bladder from the more inflated state to the less inflated state such that the inflatable drum bladder at least partially disengages from the pipe coil (process block 196) and withdrawing the inflatable pipe drum from the coil bore of the pipe coil (process block 198) while other embodiments of the process 180 do not.

In any case, as described above, an inflatable pipe drum 64 generally includes an inflatable drum bladder 66, which is to be inserted into a coil bore 50 of a pipe coil 46. In particular, an inflatable drum bladder 66 in an inflatable pipe drum 64 may generally contract radially inward when transitioned from its more (e.g., partially or fully) inflated state toward its less inflated (e.g., deflated) state and, thus, may generally be inserted into a coil bore 50 of a pipe coil 46 while in its less inflated state. Accordingly, operating an inflatable pipe drum 64 may generally include inserting the inflatable pipe drum 64 into a coil bore 50 of a pipe coil 46 while an inflatable drum bladder 66 of the inflatable pipe drum 64 is in its less inflated state (process block 182). In particular, as described above, an inflatable drum bladder 66 in an inflatable pipe drum 64 may generally transitioned from its more inflated state toward its less inflated state at least in part by extracting (e.g., releasing) inflation fluid from an internal fluid cavity 67 defined in the inflatable drum bladder 66, for example, to an inflation fluid source 70 and/or to external environmental conditions (process block 200).

After being inserted into the coil bore 50 of a pipe coil 46, an inflatable drum bladder 66 of an inflatable pipe drum 64 may be transitioned from its less inflated (e.g., deflated) state to its more (e.g., partially or fully) inflated state such that the inflatable drum bladder 66 is compressed against the pipe coil 46 and, thus, supports the pipe coil 46 from within its coil bore 50 (process block 184). In particular, as described above, an inflatable drum bladder 66 in an inflatable pipe drum 64 may generally transitioned from its less inflated state toward its more inflated state at least in part by supplying (e.g., injecting) inflation fluid from an inflation fluid source 70, such as a fluid pump or a compressed air source, to an internal fluid cavity 67 defined in the inflatable drum bladder 66 (process block 202). Additionally, as described above, to facilitate controlling fluid flow into and/or out from an internal fluid cavity 67 defined in an inflatable drum bladder 66, a fluid valve 68 may be secured to the inflatable drum bladder 66 such that the fluid valve 68 is fluidly connected to the internal fluid cavity 67. Accordingly, to facilitate locking inflation fluid in an internal fluid cavity 67 in an inflatable drum bladder 66 at an elevated fluid pressure and, thus, maintaining the inflatable drum bladder 66 in its more inflated state, a corresponding fluid valve 68 may be transitioned from its open state to its closed state (process block 204). In this manner, an inflatable pipe drum 64 may be operated to facilitate supporting a pipe coil 46 and, thus, maintaining a target (e.g., open cylindrical) shape of the pipe coil 46, which, at least in some instances, may facilitate deploying flexible pipe 20 from the pipe coil 46 into a pipeline system 10.

In fact, in some embodiments, an inflatable pipe drum 64 may be used to support a pipe coil 46 during storage and/or during transportation, for example, over a road to a target pipe deployment location in a pipeline system 10. In particular, in some such embodiments, an inflatable pipe drum 64 and a corresponding pipe coil 46 may be stored and/or transported while loaded on a pipe skid 54, for example, which is or is to be loaded on a pipe handling vehicle 136. Additionally, as described above, a pipe coil 46 may be loaded on pipe deployment equipment 116 in a pipe handling system 114 to facilitate deploying flexible pipe 20 from the pipe coil 46 at a target pipe deployment location in a pipeline system 10. Thus, in some embodiments, an inflatable pipe drum 64 and a corresponding pipe coil 46 may be transported to a target pipe deployment location in a pipeline system 10 (process block 186) and, subsequently, loaded on pipe deployment equipment 116, which was separately transported to the target pipe deployment location (process block 188). Nevertheless, in other embodiments, an inflatable pipe drum 64 and a corresponding pipe coil 46 may be loaded on pipe deployment equipment 116 (process block 188) before the pipe deployment equipment 116 is transported to a target pipe deployment location in a pipeline system 10 while the inflatable pipe drum 64 and the pipe coil 46 remain loaded thereon (process block 190).

In any case, as described above, to facilitate transporting pipe deployment equipment 116, in some embodiments, the pipe deployment equipment 116 may be loaded on a pipe handling vehicle 136, which includes a vehicle frame 138 and vehicle wheels 140 rotatably secured to the vehicle frame 138. However, in other embodiments, pipe deployment equipment 116 may include equipment wheels rotatably secured directly to its equipment base 118.

Additionally, as described above, in some embodiments, an inflatable pipe drum 64 and a corresponding pipe coil 46 may be loaded on pipe deployment equipment 116 via a pipe lifting device 96 disposed within a coil bore 50 of the pipe coil 46 (process block 206). In particular, as described above, in some embodiments, a pipe lifting device 96 may include forklift channels (e.g., pockets) 56B, which each accommodate a tine of a forklift to enable the forklift to lift the pipe lifting device 96 and, thus, a corresponding pipe coil 46. Additionally or alternatively, as described above, a pipe lifting device 96 may include pad eyes 100, which each enable one or more lifting cables to be connected to the pipe lifting device 96 and, thus, a corresponding crane to be used to lift the pipe lifting device 96 and a corresponding pipe coil 46. In any case, to enable a pipe lifting device 96 to be inserted into a coil bore 50 of a pipe coil 46, a subset of internal fluid cavities 67 in a corresponding inflatable pipe drum 64 may each be transitioned to from its more (e.g., partially or fully) inflated state to its less inflated (e.g., deflated) state, for example, while remaining internal fluid cavities are maintained in their more inflated states to continue supporting a remainder of the pipe coil 46 (process block 208).

However, as described above, in other embodiments, an inflatable drum bladder 66 of an inflatable pipe drum 64 may be disposed circumferentially around a fixed drum core 108 to enable the inflatable pipe drum 64 and, thus, a corresponding pipe coil 46 to be moved using the fixed drum core 108, for example, instead of a separate pipe lifting device 96. Accordingly, in such embodiments, loading an inflatable pipe drum 64 on pipe deployment equipment 116 may include moving the inflatable pipe drum 64 using its fixed drum core 108 (process block 210). In particular, as described above, in some such embodiments, a fixed drum core 108 in an inflatable pipe drum 64 may include forklift channels (e.g., pockets) 56C, which each accommodate a tine of a forklift to enable the forklift to move (e.g., lift) the inflatable pipe drum 64. Additionally or alternatively, to enable an inflatable pipe drum 64 to be moved (e.g., lifted) using a crane, corresponding lifting cables may be secured to (e.g., wrapped around and/or clipped to) drum shafts 112 that extend axially out from a fixed drum core 108 of the inflatable pipe drum 64.

In any case, as described above, to facilitate deploying flexible pipe 20, an inflatable pipe drum 64 and a corresponding pipe coil 46 may be loaded on pipe deployment equipment 116 such that the pipe coil 46 can rotate on the pipe deployment equipment 116. In particular, as described above, a pipe deployment cradle frame 116 generally includes an equipment base 118 and rollers 124, which are rotatably secured to the equipment base 118 and implemented to enable a pipe coil 46 to be disposed thereon, for example, directly or via drum flanges connected to a fixed drum core 108 of an inflatable pipe drum 64 on which the pipe coil 46 is disposed. Accordingly, loading a pipe coil 46 on a pipe deployment cradle frame 116 may include disposing the pipe coil 46 on rollers 124 of the pipe deployment cradle frame 116 (process block 212). Additionally, as described above, a pipe deployment A-frame 116 generally includes an equipment base 118, shaft hubs 122, which are each implemented to interlock with a drum shaft 112 of an inflatable pipe drum 64, and support arms 120, which secure the shaft hubs 122 to the equipment base 118. Accordingly, loading a pipe coil 46 onto a pipe deployment A-frame 116 may include interlocking a drum shaft 112 of an inflatable pipe drum 64 on which the pipe coil 46 is disposed with a shaft hub 122 of the pipe deployment A-frame 116 (process block 214).

In any case, as described above, in some embodiments, a subset of internal fluid cavities 67 in an inflatable pipe drum 64 may each be transitioned from its more (e.g., partially or fully) inflated state to its less inflated (e.g., deflated) state to enable a pipe lifting device 96 to be inserted into a coil bore 50 of a corresponding pipe coil 46 and, thus, used to load the pipe coil 46 and the inflatable pipe drum 64 onto pipe deployment equipment 116. Accordingly, to facilitate improving the support that the inflatable pipe drum 64 provides to the pipe coil 46 while flexible pipe 20 is being deployed therefrom, in some such embodiments, the subset of internal fluid cavities 67 may each be transitioned from its less inflated stated back to its more inflated states after the pipe lifting device 96 is withdrawn from the coil bore 50 of the pipe coil 46 (process block 215).

Additionally, as described above, to facilitate rotating a pipe coil 46 on pipe deployment equipment 116 and, thus, deploying flexible pipe 20 therefrom, a pipe attachment 126 may be secured to an outboard (e.g., free) end 128 of the flexible pipe 20 (process block 216). In particular, in some embodiments, the pipe attachment 126 secured to the outboard end 128 of a flexible pipe 20 may be a pipe anchor 126, which facilitates securing (e.g., anchoring) the outboard end 128 of the flexible pipe 20 to a fixed location. Accordingly, in such embodiments, deploying flexible pipe 20 from a pipe coil 46 disposed on an inflatable pipe drum 64, which is loaded on pipe deployment equipment 116, may include operating the pipe deployment equipment 116 or a pipe handling vehicle 136 on which the pipe deployment equipment 116 is loaded to move the pipe deployment equipment 116 and, thus, the inflatable pipe drum 64 away from the pipe attachment 126 and, thus, the outboard end 128 of the flexible pipe 20 (process block 218).

However, as described above, in other embodiments, a pipe attachment 126 secured to the outboard end 128 of a flexible pipe 20 may be a pipe pull head 126. In particular, in such embodiments, the pipe pull head 126 may be secured to and, thus, pulled by pulling equipment 130, such as a tow vehicle (e.g., truck) or a bulldozer. Accordingly, in such embodiments, deploying flexible pipe 20 from a pipe coil 46 that is disposed on an inflatable pipe drum 64, which is loaded on pipe deployment equipment 116, may include securing pulling equipment 130, such as a tow vehicle or a bulldozer, to a pipe attachment 126 (e.g., via one or more pulling cables 134) and operating the pulling equipment 130 to pull the pipe attachment 126 and, thus, the outboard end 128 of the flexible pipe 20 away from the pipe deployment equipment 116 and, thus, the inflatable pipe drum 64 (process block 220).

In any case, as described above, in some embodiments, a pipe handling system 114 may operate to continuously deploy the entire length of a flexible pipe 20, which is formed into a pipe coil 46, into a pipeline system 10. However, in other embodiments, a pipe handling system 114 may operate to separately deploy one or more segments 78 of a flexible pipe 20 from a pipe coil 46 into a pipeline system 10. In particular, to facilitate deploying a segment 78 of a flexible pipe 20 that has been unwound from a pipe coil 46 into a pipeline system 10, a pipe cutter assembly 145 in a pipe handling system 114 may be operated to cut the flexible pipe segment 78 off from the pipe coil 46 and, thus, the remainder of the flexible pipe 20 (process block 222).

In fact, in some embodiments, a pipe handling system 114 may operate in generally the same manner to deploy multiple different flexible pipe segments 78 at multiple different target pipe deployment locations. In particular, in some such embodiments, after a flexible pipe segment 78 is deployed from pipe deployment equipment 116 at a target pipe deployment location, a pipe handling system 114 may operate to transport the pipe deployment equipment 116 to another target pipe deployment location (e.g., over a road) while an inflatable pipe drum 64 and a corresponding pipe coil 46 remain loaded on the pipe deployment equipment 116 (arrow 224). Nevertheless, in other such embodiments, a pipe handling system 114 may operate to separately transport pipe deployment equipment 116 and a corresponding inflatable pipe drum 64 to another target pipe deployment location (e.g., over a road) (arrow 226).

In any case, in some embodiments, flexible pipe 20 may remain in a pipe coil 46 disposed on an inflatable pipe drum 64 after one or more flexible pipe segments 78 are deployed therefrom. To enable the inflatable pipe drum 64 to be used to support another pipe coil 46, the inflatable pipe drum 64 may be withdrawn from the coil bore 50 of the pipe coil 46 (process block 198). As described above, to facilitate supporting a pipe coil 46, an inflatable drum bladder 66 in an inflatable pipe drum 64 may be transitioned from its less inflated state to its more inflated state such that the inflatable drum bladder 66 is compressed against the pipe coil 46. Accordingly, to facilitate withdrawing an inflatable pipe drum 64 from a coil bore 50 of a pipe coil 46, an inflatable drum bladder 66 in the inflatable pipe drum 64 may be transitioned from its more inflated state to its less inflated state such that the inflatable drum bladder 66 at least in partially disengages from the pipe coil 46 (process block 196).

However, as mentioned above, in other embodiments, a pipe coil 46 may be completely unwound from an inflatable pipe drum 64. In any case, as described above, to enable an inflatable pipe drum to be disposed within a coil bore 50 of another pipe coil 46, an inflatable drum bladder 66 of the inflatable pipe drum 64 may generally transitioned from its more inflated state toward its less inflated state at least in part by extracting (e.g., releasing) inflation fluid from an internal fluid cavity 67 defined in the inflatable drum bladder 66, for example, to an inflation fluid source 70 and/or to external environmental conditions. In this manner, the present disclosure provides techniques for operating (e.g., using) an inflatable pipe drum 64 to facilitate supporting a pipe coil 46 and, thus, maintaining a target (e.g., open cylindrical) shape of the pipe coil 46, which, at least in some instances, may facilitate deploying flexible pipe 20 from the pipe coil 46 (e.g., by facilitating rotation of the pipe coil 46 on corresponding pipe deployment equipment 116), and/or transportation of the pipe coil 46 (e.g., by blocking the pipe coil 46 from inadvertently leaning beyond a boundary of a corresponding pipe skid 54 and/or a corresponding pipe handling vehicle 136).

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A system, comprising:
flexible pipe formed into a pipe coil that comprises a coil bore that extends axially therethrough, wherein tubing of the flexible pipe defines a pipe bore and a fluid conduit within a tubing annulus of the flexible pipe;
an inflatable pipe drum, wherein the inflatable pipe drum comprises:
an inflatable drum bladder that defines an internal fluid cavity, wherein the
inflatable pipe drum is configured to be inserted into the coil bore of the pipe coil while the inflatable drum bladder is in a less inflated state; and
a fluid valve secured to the inflatable drum bladder such that the fluid valve is fluidly connected to the internal fluid cavity defined in the inflatable drum bladder; and
an inflation fluid source, wherein the inflation fluid source is configured to supply inflation fluid to the internal fluid cavity defined in the inflatable drum bladder via the fluid valve to facilitate transitioning the inflatable drum bladder from the less inflated state to a more inflated state in which the inflatable drum bladder is radially compressed against the pipe coil to facilitate supporting the pipe coil from within the coil bore using the inflatable pipe drum.

2. The system of claim 1, wherein the inflatable pipe drum comprises a fixed drum core, wherein:
the fixed drum core has fixed dimensions; and
the inflatable drum bladder is disposed circumferentially around the fixed drum core.

3. The system of claim 2, wherein the fixed drum core in the inflatable pipe drum comprises forklift channels configured to accommodate tines of a forklift to enable the inflatable pipe drum and the pipe coil to be moved via the forklift.

4. The system of claim 2, wherein the fixed drum core in the inflatable pipe drum comprises a support wing that extends radially outward at an axial end of the inflatable drum bladder to facilitate blocking inadvertent axial deformation of the inflatable drum bladder.

5. The system of claim 2, comprising pipe deployment equipment, wherein:
the fixed drum core in the inflatable pipe drum comprises a drum shaft that extends axially outward; and
the pipe deployment equipment comprises:
an equipment base;
a shaft hub configured to interlock with the drum shaft of the inflatable pipe drum to enable the inflatable pipe drum and the pipe coil to rotate on the pipe deployment equipment such that flexible pipe is unwound from the inflatable pipe drum; and
a support arm that secures the shaft hub to the equipment base.

6. The system of claim 1, wherein the inflatable drum bladder of the inflatable pipe drum comprises bladder side walls that define the inflatable drum bladder with a cylindrical shape to enable the inflatable drum bladder to circumferentially support the pipe coil from within the coil bore.

7. The system of claim 6, wherein the inflatable drum bladder of the inflatable pipe drum comprises internal bladder walls that separate the internal fluid cavity defined in the inflatable pipe drum from another inflatable fluid cavity defined in the inflatable pipe drum.

8. The system of claim 1, comprising a pipe lifting device, wherein:
the inflatable drum bladder in the inflatable pipe drum defines a bladder bore that extends axially therethrough; and
the pipe lifting device is configured to be inserted into the bladder bore defined in the inflatable drum bladder to enable the pipe lifting device to be used to move the pipe coil and the inflatable drum bladder.

9. The system of claim 1, wherein:
the inflatable drum bladder of the inflatable pipe drum is a central inflatable drum bladder that has a rectangular prism shape; and
the inflatable pipe drum comprises:
a first side inflatable drum bladder that has a cylindrical segment shape and that defines another internal fluid cavity, wherein the first side inflatable drum bladder is configured to be disposed on a first side of the central inflatable drum bladder;
another fluid valve secured to the first side inflatable drum bladder such that the another fluid valve is fluidly connected to the another internal fluid cavity defined in the first side inflatable drum bladder;
a second side inflatable drum bladder that has a cylindrical segment shape and that defines a further internal fluid cavity, wherein the second side inflatable drum bladder is configured to be disposed on a second side of the central inflatable drum bladder; and
a further fluid valve secured to the second side inflatable drum bladder such that the further fluid valve is fluidly connected to the further internal fluid cavity defined in the second side inflatable drum bladder.

10. The system of claim 9, comprising a pipe lifting device, wherein:
the another fluid valve in the inflatable pipe drum is configured to enable inflation fluid to be released from the another internal fluid cavity defined in the first side inflatable drum bladder to enable the pipe lifting device to be inserted into the coil bore in the pipe coil; and
the fluid valve and the further fluid valve in the inflatable pipe drum are configured to lock inflation fluid in the internal fluid cavity defined in the central inflatable drum bladder and the further internal fluid cavity defined in the second side inflatable drum bladder at an elevated fluid pressure to facilitate continuing to support a remainder of the pipe coil while the pipe coil is being moved via the pipe lifting device.

11. The system of claim 1, wherein:
the fluid valve in the inflatable pipe drum is configured to be:
maintained in an open state to enable inflation fluid to be supplied to the internal fluid cavity defined in the inflatable drum bladder, inflation fluid to be extracted from the internal fluid cavity defined in the inflatable drum bladder, or both; and
transitioned from the open state to a closed state to facilitate locking inflation fluid within the internal fluid cavity defined in the inflatable drum bladder at an elevated fluid pressure and, thus, maintaining the inflatable drum bladder in the more inflated state; and
the inflation fluid source is configured to be disconnected from the inflatable pipe drum once the inflatable drum bladder of the inflatable pipe drum is transitioned from the less inflated state to the more inflated state.

12. The system of claim 1, comprising:
a pipe handling vehicle configured to drive over a road, wherein the pipe handling vehicle comprises a vehicle frame and vehicle wheels rotatably secured to the vehicle frame; and
a pipe skid configured to be loaded on the pipe handling vehicle, wherein the inflatable pipe drum and the pipe coil are configured to be disposed on the pipe skid such that the inflatable pipe drum facilitates blocking the pipe coil from inadvertently leaning beyond a boundary of the pipe skid or the pipe handling vehicle.

13. A method of using an inflatable pipe drum, comprising:
inserting the inflatable pipe drum into a coil bore of a pipe coil that is formed from flexible pipe while an inflatable drum bladder of the inflatable pipe drum is in a less inflated state;
supplying inflation fluid from an inflation fluid source to an internal fluid cavity defined within the inflatable drum bladder via a fluid valve secured to the inflatable drum bladder to transition the inflatable drum bladder from the less inflated state to a more inflated state in which the inflatable drum bladder is circumferentially compressed against the pipe coil to facilitate supporting the pipe coil from within the coil bore using the inflatable pipe drum; and
disconnecting the inflation fluid source from the fluid valve of the inflatable pipe drum after the inflatable drum bladder is transitioned to the more inflated state.

14. The method of claim 13, comprising:
loading the inflatable pipe drum and the pipe coil on pipe deployment equipment; and
rotating the inflatable pipe drum and the pipe coil on the pipe deployment equipment to deploy flexible pipe into a pipeline system.

15. The method of claim 14, wherein loading the inflatable pipe drum and the pipe coil on the pipe deployment equipment comprises:
inserting tines of a forklift into forklift channels defined in a fixed drum core of the inflatable pipe drum, wherein the fixed drum core has fixed dimensions and the inflatable drum bladder is disposed circumferentially around the fixed drum core; and
lifting the inflatable pipe drum and the pipe coil using the forklift.

16. The method of claim 14, wherein loading the inflatable pipe drum and the pipe coil on the pipe deployment equipment comprising interlocking a drum shaft that extends out axially from a fixed drum core in the inflatable pipe drum with a shaft hub of the pipe deployment equipment, wherein the fixed drum core has fixed dimensions and the inflatable drum bladder is disposed circumferentially around the fixed drum core.

17. The method of claim 13, comprising:
disposing the pipe coil on a pipe skid before the inflatable pipe drum is inserted into the coil bore of the pipe coil;
loading the inflatable pipe drum and the pipe coil on a pipe handling vehicle via the pipe skid; and
moving the pipe handling vehicle over a road with the inflatable pipe drum and the pipe coil loaded thereon while the inflatable drum bladder in the inflatable pipe drum is in the more inflated state to facilitate blocking the pipe coil from inadvertently leaning beyond a boundary of pipe skid or the pipe handling vehicle.

18. An inflatable pipe drum, comprising:
an inflatable drum bladder, wherein:
the inflatable drum bladder comprises bladder walls that define an internal fluid cavity within the inflatable drum bladder such that the inflatable drum bladder has a cylindrical shape; and
the inflatable pipe drum is configured to be inserted into a coil bore of a pipe coil while the inflatable drum bladder is in a less inflated state; and
a fluid valve secured to a bladder wall of the inflatable drum bladder such that the fluid valve opens through the bladder wall to the internal fluid cavity defined in the inflatable drum bladder, wherein the fluid valve is configured to:
maintain an open state to enable inflation fluid to be supplied from an inflation fluid source to the internal fluid cavity defined in the inflatable drum bladder to facilitate transitioning the inflatable drum bladder from the less
inflated state to a more inflated state in which the inflatable drum bladder is circumferentially compressed against the pipe coil and, thus, supports the pipe coil from within the coil bore of the pipe coil; and
transition from the open state to a closed state to lock inflation fluid in the internal fluid cavity defined in the inflatable drum bladder at an elevated fluid pressure to facilitate maintaining the inflatable drum bladder in the more inflated state.

19. The inflatable pipe drum of claim 18, wherein the fluid valve is configured to transition from the closed state to the open state to enable inflation fluid to be extracted from the internal fluid cavity defined in the inflatable drum bladder to facilitate transitioning the inflatable drum bladder from the more inflated state to the less inflated state such that the inflatable drum bladder is at least partially disengaged from the pipe coil.

20. The inflatable pipe drum of claim 18, comprising a fixed drum core, wherein:
the fixed drum core has fixed dimensions;
the inflatable drum bladder is disposed circumferentially around the fixed drum core; and
the fixed drum core comprises forklift pockets configured to accommodate tines of a forklift to facilitate moving the inflatable pipe drum using the forklift, drum shafts that are configured to interlock with shaft hubs on pipe deployment equipment to facilitate rotating the inflatable pipe drum on the pipe deployment equipment, or both.
